(19) United States
(12) Patent Application Publication
(10) Pub. No.: US 2022/0336925 A1
(43) Pub. Date: Oct. 20, 2022

(54) DUAL-LAYER SEPARATOR FOR BATTERIES

(71) Applicant: Hollingsworth & Vose Company, East Walpole, MA (US)

(72) Inventor: Zhiping Jiang, Nashua, NH (US)

(73) Assignee: Hollingsworth & Vose Company, East Walpole, MA (US)

(21) Appl. No.: 17/232,060

(22) Filed: Apr. 15, 2021

(51) Int. Cl. H01M 50/449; H01M 10/06; H01M 50/44; H01M 50/437; H01M 50/491; H01M 50/446; H01M 50/42; H01M 50/403

(52) U.S. Cl. CPC H01M 50/449; H01M 10/06; H01M 50/44; H01M 50/437; H01M 50/491; H01M 50/446; H01M 50/42; H01M 50/403

(57) ABSTRACT

Battery separators, and lead-acid batteries comprising battery separators, are generally provided. In some embodiments, the battery separators described herein have one or more features that enhance their suitability for various applications (e.g., lead-acid battery applications). In one embodiment, a battery separator described herein comprises at least two phases. In some cases, each phase may have a one or more features that result in a battery separator having enhanced physical properties. For example, the dual-phase battery separator may exhibit reduced electrical and ionic resistance, enhanced acid filling capacity, reduced acid stratification, and enhanced thermal and oxidative stability compared to conventional battery separators.

### FIELD

The present invention relates generally to separators for batteries, and, more particularly, to separators for lead-acid batteries.

### BACKGROUND

Separators are typically employed in batteries to separate the battery plates therein. However, many such separators are undesirable for emerging lead-acid battery applications for a number of reasons. For instance, such separators may have a higher acid stratification, a higher electrical resistance, a lower thermal and oxidative stability, and/or a lower mechanical robustness than desired. Accordingly, improved separator designs are needed.

### SUMMARY

Battery separators, lead-acid batteries, related components, and related methods are generally described.

In some embodiments, a lead-acid battery is provided. The lead-acid battery comprises battery plates and a battery separator. The battery separator comprises a first phase and a second phase. The first phase comprises fibers. The second phase comprises fibers. The first phase has a mean flow pore size of greater than or equal to 2 microns and less than or equal to 15 microns. The second phase has a mean flow pore size of greater than or equal to 20 microns and less than or equal to 150 microns. The battery separator has an air permeability of greater than or equal to 3 CFM and less than or equal to 30 CFM.

In some embodiments, a battery separator is provided. The battery separator comprises a first phase and a second phase. Glass fibers make up greater than 40 wt % of the first phase. Glass fibers make up greater than 40 wt % of the second phase. The first phase comprises fibers having an average fiber diameter of greater than or equal to 0.5 microns and less than or equal to 12 microns. The second phase comprises fibers having an average fiber diameter of greater than or equal to 5 microns and less than or equal to 20 microns. A ratio of the thickness of the second phase to the thickness of the first phase is greater than or equal to 1.15. An acid-stable binder resin makes up greater than or equal to 2 wt % and less than or equal to 30 wt % of the battery separator. The battery separator has an air permeability of greater than or equal to 3 CFM and less than or equal to 30 CFM.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic depiction of a cross-section of a battery separator, according to one set of embodiments;

FIG. 2 is a schematic depiction of a cross-section of a portion of the inside of a battery, according to one set of embodiments;

FIGS. 3A-3B are SEM images of a fine phase (FIG. 3A) and a coarse phase (FIG. 3B) of a battery separator, according to one set of embodiments;

FIGS. 4A-4B are SEM images of a fine phase of a battery separator before storage in acid (FIG. 4A) and after 3 weeks of storage in acid (FIG. 4B), according to one set of embodiments;

FIGS. 5A-5B are SEM images of a coarse phase of a battery separator before storage in acid (FIG. 5A) and after 3 weeks of storage in acid (FIG. 5B), according to one set of embodiments;

FIG. 6 is a photograph of a crimped battery separator, according to one set of embodiments; and

FIG. 7 is a plot of discharge data for 2V cells during a cold-crank test, according to one set of embodiments.

### DETAILED DESCRIPTION

Battery separators, and lead-acid batteries comprising battery separators, are generally provided. In some embodiments, the battery separators described herein have one or more features that enhance their suitability for lead-acid batteries. For example, a battery separator described herein may comprise at least two phases comprising different pluralities of fibers. In some such embodiments, each phase may have one or more features and/or properties that results in a battery separator having enhanced physical properties. In some embodiments, a battery separator comprises two or more phases that, together, cause the battery separator to exhibit improved performance.

By way of example, in some embodiments, a battery separator described herein may comprise a tight phase having a finer pore structure and an open phase having a more open pore structure. In some such cases, the open phase may have a larger air permeability and/or larger mean flow pore size compared to the tight phase. Without wishing to be bound theory, it has been hypothesized that the large pores in the open phase may allow for efficient acid filling, diffusion, and mixing. Accordingly, a battery separator comprising such an open phase may advantageously exhibit reduced ionic resistance, enhanced acid filling capacity, reduced acid stratification, and/or longer cycle life, compared to an otherwise-equivalent battery separator lacking the phase of the second type. Additionally, the presence of small pores in the tight phase of a battery separator may assist with reducing acid stratification and/or preventing dendrite formation and/or shorts in a battery comprising the battery separator.

In some embodiments, a dual-phase battery separator described herein comprises one or more components that enhance its performance. For instance, a battery separator may comprise an appreciable amount of one or more types of fibers (e.g., glass fibers, synthetic polyester fibers) that are chemically and/or thermally stable, such that the battery separator exhibits enhanced thermal stability and/or enhanced oxidative stability.

In some embodiments, a battery separator may comprise an appreciable amount of one or more types of fibers (e.g., microglass fibers) that can advantageously assist with reducing acid stratification within a lead-acid battery. In some such embodiments, the one or more types of fibers may comprise fibers that are hydrophilic. The hydrophilic fibers may adsorb water and/or acid molecules, and/or may have an affinity to bind to water and/or acid molecules. This binding may slow down the rate of acid stratification by retarding acid and/or water diffusion. Some fibers included in the battery separators described herein, such as microglass fibers, may be both hydrophilic and have a relatively high surface area. Such fibers may adsorb a relatively high amount of water and/or acid molecules, which may result in reduced acid stratification within the separator.

Furthermore, as described in more detail below, the presence of synthetic fibers in a battery separator described herein may impart the battery separator with relatively high degree of crimpability, such that the separator may be easily crimped and/or sealed. As another example, in some embodiments, a battery separator described herein advantageously includes an acid-stable binder resin such that the separator exhibits enhanced mechanical robustness (e.g., high tensile strength, flexibility, and/or puncture strength) and/or slower degradation in the acidic environment present in lead-acid batteries.

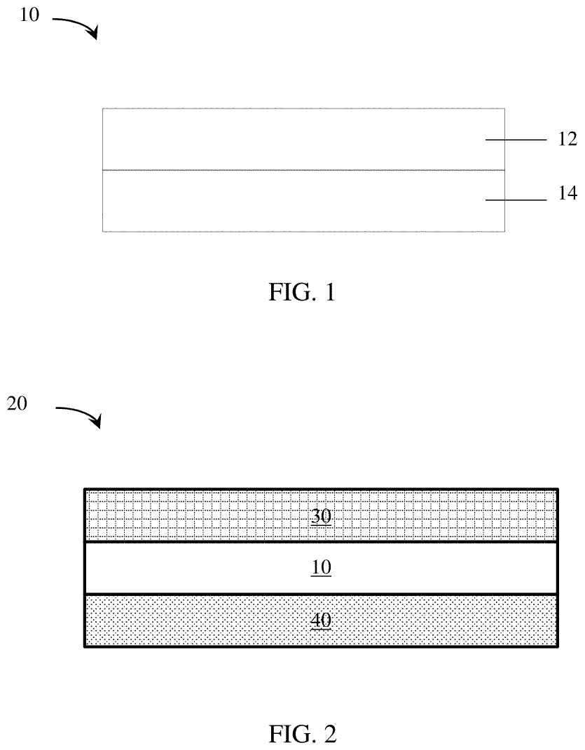

A non-limiting example of a battery separator comprising two phases is shown schematically in FIG. 1. In some embodiments, a battery separator 10 includes a first phase 12 and a second phase 14. The first phase and/or the second phase may be fibrous. In some embodiments, a battery separator comprises a second phase that differs from the first phase in one or more ways. In some embodiments, the first and second phases may differ in composition (e.g., fiber composition, presence or absence of binder, binder composition) and/or physical properties (e.g., permeability, mean flow pore size, basis weight, and/or thickness). For example, in some embodiments, the second phase is a phase that has a relatively more open pore structure (e.g., that has a larger air permeability and/or mean flow pore size) compared to the first phase. In some cases, a phase having a more open pore structure may be referred to as an open phase, whereas a phase having a finer pore structure may be referred to as a tight phase.

The phases described herein may have a variety of suitable morphologies. For instance, some phases may be fibrous. A fibrous phase may take the form of a battery separator (e.g., in its entirety) or a portion thereof. In some embodiments, a battery separator comprises two or more phases, one or more of which are fibrous. As one example, a battery separator may comprise one or more fibrous phases that are fibrous layers. As another example, a battery separator may comprise a single fibrous layer that comprises two or more fibrous phases (e.g., each of the two or more fibrous phases in the fibrous layer may be a component of the fibrous layer). In some embodiments, a battery separator comprises a phase that is a non-woven fiber web. It is also possible for a battery separator to comprise a non-woven fiber web that comprises two or more fibrous phases (e.g., each of the two or more fibrous phases in the non-woven fiber web may be a fibrous phase).

When a battery separator comprises two or more fibrous phases that are positioned in different layers and/or non-woven fiber webs (e.g., in the case where each fibrous phase takes the form of an entire layer and/or non-woven fiber web, in the case where at least one of the fibrous phases takes the form of a portion of a layer and/or non-woven fiber web that is different from the layer and/or non-woven fiber web in which the other fibrous phase forms or is positioned), those fibrous phases may be discrete from each other. In other words, such fibrous phases may be separated by an identifiable interface, may lack fibers that intermingle with each other, and/or may be capable of being separated without the use of specialized tools. When a battery separator comprises two or more fibrous phases that are positioned in the same layer and/or non-woven fiber web, those fibrous phases may be joined together and/or interpenetrate to form a single layer and/or non-woven fiber web. In some such embodiments, the two or more fibrous phases may lack a clear interface along which they are separated, may comprise fibers that intermingle with those of the other phase, and/or may be integrally connected to each other.

As described above, in one set of embodiments, a battery separator comprises two phases that are each non-woven fiber webs. For instance, a battery separator may comprise a first phase that is a first non-woven fiber web and a second phase that is a second non-woven fiber web. In some such embodiments, each non-woven fiber web may be formed separately and combined to form a battery separator. The two or more phases may be formed using different processes, or the same process. For example, each of the phases may be independently formed by a wet laid process, a non-wet laid process, or any other suitable process. Discrete phases (e.g., discrete non-woven fiber webs) may be joined by any suitable process including, for example, lamination, thermo-dot bonding, calendering, ultrasonic processes, or the use of an adhesive, as described in more detail below.

It should be appreciated, however, that certain embodiments may include phases that are not discrete with respect to one another. For example, in one set of embodiments, a battery separator is a single non-woven fiber web comprising a first phase and a second phase, and each of the first phase and the second phase forms a portion of the single non-woven fiber web. In some such embodiments, the first phase and the second phase may be formed simultaneously via a single process (e.g., a wet-laid process) as described in more detail below. In some embodiments, the first phase may be formed on top of the second phase or vice versa during a wet-laid process. In some such embodiments, the first phase and the second phase of the battery separator do not have macroscopic phase separation as shown in a conventional multi-phase battery separator (e.g., where a first fiber web is laminated onto another fiber web), but instead contain an interface across which a microscopic phase transition occurs.

In some embodiments, one or more of the phases described herein may also include a plurality of inorganic particles. In other embodiments, one or more of the phases described herein may be substantially free of inorganic particles.

It should be understood that the configuration of the phases shown in FIG. 1 is by way of example only, and that battery separators including other configurations of phases may be possible. Furthermore, in some embodiments, additional phases (e.g., a third phase, a fourth phase, etc.) may be present in addition to and/or instead of the phases shown in FIG. 1. It should also be appreciated that not all components shown in FIG. 1 need be present in some embodiments.

In some embodiments, a battery separator described herein may be used in a battery (e.g., lead acid battery). The battery may comprise a negative plate, a positive plate, and a battery separator (e.g., including the phases described herein) disposed between the negative and positive plates. FIG. 2 shows one non-limiting embodiment of a battery 20 comprising a battery separator (e.g., battery separator 10). As shown in FIG. 2, a battery may comprise a battery separator 10 positioned between and in direct contact with a negative plate 30 and a positive plate 40. In some embodiments, a battery separator is planar in shape and the entire surface area of the negative plate and the positive plate are in contact with the planar battery separator. It should also be understood that some embodiments may relate to batteries comprising further components in addition to those shown in FIG. 2 (e.g., a second separator, an electrolyte, an encasement, external wiring, etc.). Some of these components will be described in further detail below.

In some embodiments, a battery separator comprises one or more phases. As noted above, one such phase may be a relatively tight phase and/or may have a relatively fine pore structure. This phase may be referred to elsewhere herein as a “phase of the first type”. Advantageously, the presence of a relatively fine pore structure in a phase of the first type may assist with preventing shorts, preventing dendrite formation, and/or reducing acid stratification in a battery comprising the battery separator.

A phase of the first type may comprise fibers having a variety of suitable average fiber diameters. In some embodiments, a phase of the first type comprises fibers having an average fiber diameter of greater than or equal to 0.5 microns, greater than or equal to 0.6 microns, greater than or equal to 0.7 microns, greater than or equal to 0.8 microns, greater than or equal to 1 micron, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, or greater than or equal to 11 microns. In some embodiments, a phase of the first type comprises fibers having an average fiber diameter of less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1 micron, less than or equal to 0.8 microns, less than or equal to 0.7 microns, or less than or equal to 0.6 microns. Combinations of the above-referenced ranges are also possible (e.g., greater than or equal to 0.5 microns and less than or equal to 12 microns, greater than or equal to 1 micron and less than or equal to 12 microns, greater than or equal to 1.5 microns and less than or equal to 10 microns, or greater than or equal to 2 microns and less than or equal to 8 microns). Other ranges are also possible.

When a phase of the first type comprises two or more types of fibers, each type of fiber may independently have an average fiber diameter in one or more of the ranges described above and/or all of the fibers together may have an average fiber diameter in one or more of the ranges described above. Similarly, when a battery separator comprises two or more phases of the first type, each phase of the first type may independently comprise fibers having an average fiber diameter in one or more of the ranges described above and/or may comprise fibers together having an average fiber diameter in one or more of the ranges described above.

In some embodiments, a phase of the first type includes glass fibers. In some embodiments, a phase of the first type comprises two or more types of glass fibers. In some cases, the two or more types of glass fibers may differ in composition (e.g., fiber type) and/or physical properties (e.g., average fiber diameter and/or average fiber length). In some embodiments, a non-woven fiber web of the first type comprises glass fibers that comprise microglass fibers, chopped strand fibers, or both.

In some embodiments, glass fibers may make up a relatively large amount of a phase of the first type. In some embodiments, glass fibers make up greater than or equal to 40 wt %, greater than 40 wt %, greater than or equal to 45 wt %, greater than or equal to 50 wt %, greater than or equal to 55 wt %, greater than 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of a phase of the first type. In some embodiments, glass fibers make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 50 wt %, or less than or equal to 45 wt % of a phase of the first type. Combinations of the above-referenced ranges are also possible (e.g., greater than or equal to 40 wt % and less than or equal to 95 wt %, greater than 40 wt % and less than or equal to 95 wt %, greater than or equal to 55 wt % and less than or equal to 85 wt %, or greater than or equal to 70 wt % and less than or equal to 80 wt %). Other ranges are also possible.

When a phase of the first type comprises two or more types of glass fibers, each type of glass fiber may independently make up an amount in one or more of the ranges described above and/or all of the glass fibers together may make up an amount in one or more of the ranges described above. Similarly, when a battery separator comprises two or more phases of the first type, each phase of the first type may independently comprise an amount of any particular type of glass fiber in one or more of the ranges described above and/or may comprise a total amount of glass fibers in one or more of the ranges described above.

The phases of the first type described herein may comprise glass fibers having a variety of suitable average fiber diameters. In some embodiments, a phase of the first type comprises glass fibers having an average fiber diameter of greater than or equal to 0.5 microns, greater than or equal to 0.6 microns, greater than or equal to 0.8 microns, greater than or equal to 1 micron, greater than or equal to 1.5 microns, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, or greater than or equal to 9 microns. In some embodiments, a phase of the first type comprises glass fibers having an average fiber diameter of less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1 micron, less than or equal to 0.8 microns, or less than or equal to 0.6 microns. Combinations of the above-referenced ranges are also possible (e.g., greater than or equal to 0.5 microns and less than or equal to 10 microns, greater than or equal to 0.8 microns and less than or equal to 8 microns, or greater than or equal to 1 micron and less than or equal to 5 microns). Other ranges are also possible.

When a phase of the first type comprises two or more types of glass fibers, each type of glass fiber may independently have an average fiber diameter in one or more of the ranges described above and/or all of the glass fibers together may together have an average fiber diameter in one or more of the ranges described above. Similarly, when a battery separator comprises two or more phases of the first type, each phase of the first type may independently comprise glass fibers having an average fiber diameter in one or more of the ranges described above and/or may comprise glass fibers together having an average fiber diameter in one or more of the ranges described above.

In some embodiments, a phase of the first type comprises microglass fibers. The microglass fibers may comprise microglass fibers drawn from bushing tips and further subjected to flame blowing or rotary spinning processes. In some cases, microglass fibers may be made using a remelting process. The microglass fibers may be microglass fibers for which alkali metal oxides (e.g., sodium oxides, magnesium oxides) make up 10-20 wt % of the fibers. Such fibers may have relatively low melting and processing temperatures. Non-limiting examples of microglass fibers are B glass fibers, M glass fibers according to Man Made Vitreous Fibers by Nomenclature Committee of TIMA Inc. March 1993, Page 45, C glass fibers (e.g., Lauscha C glass fibers, JM 253 C glass fibers), and non-persistent glass fibers (e.g., fibers that are configured to dissolve completely in the fluid present in human lungs in less than or equal to 40 days, such as Johns Manville 481 fibers). It should be understood that microglass fibers present in a phase of the first type may comprise one or more of the types of microglass fibers described herein.

The phases of the first type described herein may comprise microglass fibers having a variety of suitable average fiber diameters. In some embodiments, a phase of the first type comprises one type of microglass fiber that has a relatively small average fiber diameter. In some such embodiments, a phase of the first type comprises microglass fibers having an average fiber diameter of greater than or equal to 0.5 microns, greater than or equal to 0.6 microns, greater than or equal to 0.8 microns, greater than or equal to 1 micron, greater than or equal to 1.5 microns, greater than or equal to 2 microns, greater than or equal to 2.5 microns, greater than or equal to 3 microns, greater than or equal to 3.5 microns, greater than or equal to 4 microns, or greater than or equal to 4.5 microns. In some embodiments, a phase of the first type comprises microglass fibers having an average fiber diameter of less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.5 microns, less than or equal to 1 micron, less than or equal to 0.8 microns, or less than or equal to 0.6 microns. Combinations of the above-referenced ranges are also possible (e.g., greater than or equal to 0.5 microns and less than or equal to 5 microns, greater than or equal to 0.8 microns and less than or equal to 4 microns, or greater than or equal to 1 micron and less than or equal to 3 microns). Other ranges are also possible.

When a battery separator comprises two or more phases of the first type, each phase of the first type may independently comprise microglass fibers having a relatively small average fiber diameter in one or more of the ranges described above and/or may comprise microglass fibers together having an average fiber diameter in one or more of the ranges described above.

In some embodiments, a phase of the first type comprises an appreciable number of microglass fibers having a relatively small average fiber diameter. In some embodiments, the microglass fibers having the relatively small average fiber diameter make up greater than or equal to 40 wt %, greater than 40 wt %, greater than or equal to 45 wt %, greater than or equal to 50 wt %, greater than or equal to 55 wt %, greater than 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of a phase of the first type. Microglass fibers having a relatively small average fiber diameter may make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 50 wt %, or less than or equal to 45 wt % of a phase of the first type. Combinations of the above-referenced ranges are also possible (e.g., greater than or equal to 40 wt % and less than or equal to 95 wt %, greater than 40 wt % and less than or equal to 95 wt %, greater than or equal to 55 wt % and less than or equal to 85 wt %, or greater than or equal to 70 wt % and less than or equal to 80 wt %). Other ranges are also possible.

When a battery separator comprises two or more phases of the first type, each phase of the first type may independently comprise an amount of microglass fibers having a relatively small average fiber diameter in one or more of the above-referenced ranges.

In some embodiments, a phase of the first type comprises one type of microglass fiber that has a relatively large average fiber diameter. In some such embodiments, a phase of the first type comprises microglass fibers having an average fiber diameter of greater than 5 microns, greater than or equal to 5.5 microns, greater than or equal to 6 microns, greater than or equal to 6.5 micron, greater than or equal to 7 microns, greater than or equal to 7.5 microns, greater than or equal to 8 microns, greater than or equal to 8.5 microns, greater than or equal to 9 microns, or greater than or equal to 9.5 microns. In some embodiments, a phase of the first type comprises microglass fibers having an average fiber diameter of less than or equal to 10 microns, less than or equal to 9.5 microns, less than or equal to 9 microns, less than or equal to 8.5 microns, less than or equal to 8 microns, less than or equal to 7.5 microns, less than or equal to 7 microns, less than or equal to 6.5 microns, less than or equal to 6 microns, or less than or equal to 5.5 microns. Combinations of the above-referenced ranges are also possible (e.g., greater than 5 microns and less than or equal to 10 microns). Other ranges are also possible.

When a battery separator comprises two or more phases of the first type, each phase of the first type may independently comprise microglass fibers having a relatively large average fiber diameter having an average fiber diameter in one or more of the above-referenced ranges.

In some embodiments, a phase of the first type comprises a relatively small amount of microglass fibers having a relatively large average fiber diameter. In some embodiments, the microglass fibers having a relatively large average fiber diameter make up greater than or equal to 0 wt %, greater than or equal to 2.5 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, or greater than or equal to 37.5 wt % of a phase of the first type. Microglass fibers having a relatively large average fiber diameter may make up less than or equal to 40 wt %, less than or equal to 37.5 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, or less than or equal to 5 wt % of a phase of the first type. Combinations of the above-referenced ranges are also possible (e.g., greater than or equal to 0 wt % and less than or equal to 40 wt %, greater than or equal to 0 wt % and less than or equal to 30 wt %, or greater than or equal to 0 wt % and less than or equal to 20 wt %). Other ranges are also possible. In some embodiments, the phase of the first type described herein does not include any glass fibers having a relatively large average fiber diameter.

When a battery separator comprises two or more phases of the first type, each phase of the first type may independently comprise an amount of microglass fibers having a relatively large average fiber diameter in one or more of the above-referenced ranges.

In some embodiments, a phase of the first type comprises chopped strand glass fibers. The chopped strand glass fibers may comprise chopped strand glass fibers which were produced by drawing a melt of glass from bushing tips into continuous fibers and then cutting the continuous fibers into short fibers. In some embodiments, a phase of the first type comprises chopped strand glass fibers for which alkali metal oxides (e.g., sodium oxides, magnesium oxides) make up a relatively low amount of the fibers. It is also possible for a phase to comprise chopped strand glass fibers that include relatively large amounts of calcium oxide and/or alumina (Al₂O₃). In some embodiments, a phase of the first type comprises S-glass fibers, which include approximately 10 wt % magnesium oxide. It should be understood that chopped strand glass fibers present in a phase of the first type may comprise one or more of the types of chopped strand glass fibers described herein.

The phases of the first type described herein may comprise chopped strand glass fibers in variety of suitable amounts. In some embodiments, chopped strand glass fibers make up greater than or equal to 5 wt %, greater than or equal to 6 wt %, greater than or equal to 7 wt %, greater than or equal to 8 wt %, greater than or equal to 9 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, or greater than or equal to 27.5 wt % of a phase of the first type. In some embodiments, chopped strand glass fibers make up less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 9 wt %, less than or equal to 8 wt %, less than or equal to 7 wt %, or less than or equal to 6 wt % of a phase of the first type. Combinations of the above-referenced ranges are also possible (e.g., greater than or equal to 5 wt % and less than or equal to 30 wt %, greater than or equal to 7 wt % and less than or equal to 25 wt %, or greater than or equal to 10 wt % and less than or equal 20 wt %). Other ranges are also possible.

When a phase of the first type comprises two or more types of chopped strand glass fibers, each type of chopped strand glass fiber may independently make up an amount of the phase of the first type in one or more of the ranges described above and/or all of the chopped strand glass fibers in a phase of the first type may together make up an amount of the phase of the first type in one or more of the ranges described above. Similarly, when a battery separator comprises two or more phases of the first type, each phase of the first type may independently comprise an amount of any particular type of chopped strand glass fiber in one or more of the ranges described above and/or may comprise a total amount of chopped strand glass fibers in one or more of the ranges described above.

Chopped strand glass fibers present in phases of the first type may have a variety of suitable average fiber diameters. In some embodiments, a phase of the first type comprises chopped strand glass fibers having an average fiber diameter of greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, or greater than or equal to 19 microns. In some embodiments, a phase of the first type comprises chopped strand glass fibers having an average fiber diameter of less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, or less than or equal to 9 microns. Combinations of the above-referenced ranges are also possible (e.g., greater than or equal to 8 microns and less than or equal to 20 microns, greater than or equal to 10 microns and less than or equal to 17 microns, or greater than or equal to 12 microns and less than or equal to 15 microns). Other ranges are also possible.

When a phase of the first type comprises two or more types of chopped strand glass fibers, each type of chopped strand glass fiber may independently have an average fiber diameter in one or more of the ranges described above and/or all of the chopped strand glass fibers in the phase of the first type may together have an average fiber diameter in one or more of the ranges described above. Similarly, when a battery separator comprises two or more phases of the first type, each phase of the first type may independently comprise one or more types of chopped strand glass fibers having an average fiber diameter in one or more of the ranges described above and/or may comprise chopped strand glass fibers that overall have an average fiber diameter in one or more of the ranges described above.

Chopped strand glass fibers present in the phases of the first type described herein may have a variety of suitable lengths. In some embodiments, a phase of the first type comprises chopped strand glass fibers having an average fiber length of greater than or equal to 6 mm, greater than or equal to 7 mm, greater than or equal to 8 mm, greater than or equal to 9 mm, greater than or equal to 10 mm, greater than or equal to 12 mm, greater than or equal to 14 mm, greater than or equal to 16 mm, greater than or equal to 18 mm, greater than or equal to 20 mm, greater than or equal to 22 mm, or greater than or equal to 24 mm. In some embodiments, a phase of the first type comprises chopped strand glass fibers having an average fiber length of less than or equal to 25 mm, less than or equal to 24 mm, less than or equal to 22 mm, less than or equal to 20 mm, less than or equal to 18 mm, less than or equal to 16 mm, less than or equal to 14 mm, less than or equal to 12 mm, less than or equal to 10 mm, less than or equal to 9 mm, less than or equal to 8 mm, or less than or equal to 7 mm. Combinations of the above-referenced ranges are also possible (e.g., greater than or equal to 6 mm and less than or equal to 25 mm, greater than or equal to 8 mm and less than or equal to 20 mm, or greater than or equal to 10 mm and less than or equal to 16 mm). Other ranges are also possible.

When a phase of the first type comprises two or more types of chopped strand glass fibers, each type of chopped strand glass fiber may independently have an average fiber length in one or more of the ranges described above and/or all of the chopped strand glass fibers in the phase of the first type may together have an average fiber length in one or more of the ranges described above. Similarly, when a battery separator comprises two or more phases of the first type, each phase of the first type may independently comprise one or more types of chopped strand glass fibers having an average fiber length in one or more of the ranges described above and/or may comprise chopped strand glass fibers that overall have an average fiber length in one or more of the ranges described above.

In some embodiments, a phase of the first type comprises one type of glass fiber that has a relatively small average fiber diameter. The fibers having a relatively small average fiber diameter may comprise microglass fibers.

In some embodiments, a phase of the first type comprises an appreciable number of glass fibers having a relatively small average fiber diameter. In some embodiments, the glass fibers having the relatively small average fiber diameter make up greater than or equal to 40 wt %, greater than 40 wt %, greater than or equal to 45 wt %, greater than or equal to 50 wt %, greater than or equal to 55 wt %, greater than 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of a phase of the first type. Glass fibers having a relatively small average fiber diameter may make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 50 wt %, or less than or equal to 45 wt % of a phase of the first type. Combinations of the above-referenced ranges are also possible (e.g., greater than or equal to 40 wt % and less than or equal to 95 wt %, greater than 40 wt % and less than or equal to 95 wt %, greater than or equal to 55 wt % and less than or equal to 85 wt %, or greater than or equal to 70 wt % and less than or equal to 80 wt %). Other ranges are also possible.

When a battery separator comprises two or more phases of the first type, each phase of the first type may independently comprise an amount of glass fibers having a relatively small average fiber diameter in one or more of the above-referenced ranges.

Glass fibers having a relatively small average fiber diameter may have an average fiber diameter of greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 1.25 microns, greater than or equal to 1.5 microns, greater than or equal to 1.75 microns, greater than or equal to 2 microns, greater than or equal to 2.5 microns, greater than or equal to 3 microns, greater than or equal to 3.5 microns, greater than or equal to 4 microns, or greater than or equal to 4.5 microns. Glass fibers having a relatively small average fiber diameter may have an average fiber diameter of less than or equal to 5 microns, less than or equal to 4.5 microns, less than or equal to 4 microns, less than or equal to 3.5 microns, less than or equal to 3 microns, less than or equal to 2.5 microns, less than or equal to 2 microns, less than or equal to 1.75 microns, less than or equal to 1.5 microns, less than or equal to 1.25 microns, less than or equal to 1 micron, less than or equal to 0.9 microns, less than or equal to 0.8 microns, less than or equal to 0.7 microns, or less than or equal to 0.6 microns. Combinations of the above-referenced ranges are also possible (e.g., greater than or equal to 0.5 microns and less than or equal to 5 microns, greater than or equal to 0.8 microns and less than or equal to 3 microns, greater than or equal to 1 micron and less than or equal to 2 microns). Other ranges are also possible.

When a battery separator comprises two or more phases of the first type, each phase of the first type may independently comprise glass fibers having a relatively small average fiber diameter having an average fiber diameter in one or more of the above-referenced ranges.

In some embodiments, a phase of the first type comprises a relatively small amount of glass fibers having a relatively large average fiber diameter. In some embodiments, the glass fibers having a relatively large average fiber diameter make up greater than or equal to 0 wt %, greater than or equal to 2.5 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, or greater than or equal to 37.5 wt % of a phase of the first type. Glass fibers having a relatively large average fiber diameter may make up less than or equal to 40 wt %, less than or equal to 37.5 wt %, less than or equal to 35 wt %, less than or equal to 30 wt %, less than or equal to 25 wt %, less than or equal to 20 wt %, less than or equal to 15 wt %, less than or equal to 10 wt %, less than or equal to 7.5 wt %, or less than or equal to 5 wt % of a phase of the first type. Combinations of the above-referenced ranges are also possible (e.g., greater than or equal to 0 wt % and less than or equal to 40 wt %, greater than or equal to 0 wt % and less than or equal to 30 wt %, or greater than or equal to 0 wt % and less than or equal to 20 wt %). Other ranges are also possible. In some embodiments, the phase of the first type described herein does not include any glass fibers having a relatively large average fiber diameter.

When a battery separator comprises two or more phases of the first type, each phase of the first type may independently comprise an amount of glass fibers having a relatively large average fiber diameter in one or more of the above-referenced ranges.

Glass fibers having a relatively large average fiber diameter may have an average fiber diameter of greater than 5 microns, greater than or equal to 5.5 microns, greater than or equal to 6 microns, greater than or equal to 6.5 microns, greater than or equal to 7 microns, greater than or equal to 7.5 microns, greater than or equal to 8 microns, greater than or equal to 8.5 microns, greater than or equal to 9 microns, greater than or equal to 9.5 microns, greater than or equal to 10 microns, greater than or equal to 11 microns, greater than or equal to 13 microns, greater than or equal to 15 microns, greater than or equal to 17 microns, or greater than or equal to 19 microns. Glass fibers having a relatively large average fiber diameter may have an average fiber diameter of less than or equal to 20 microns, less than or equal to 19 microns, less than or equal to 17 microns, less than or equal to 15 microns, less than or equal to 13 microns, less than or equal to 11 microns, less than or equal to 10 microns, less than or equal to 9.5 microns, less than or equal to 9 microns, less than or equal to 8.5 microns, less than or equal to 8 microns, less than or equal to 7.5 microns, less than or equal to 7 microns, less than or equal to 6.5 microns, less than or equal to 6 microns, or less than or equal to 5.5 microns. Combinations of the above-referenced ranges are also possible (e.g., greater than 5 microns and less than or equal to 20 microns, greater than or equal to 6 microns and less than or equal to 17 microns, greater than or equal to 7 microns and less than or equal to 15 microns). Other ranges are also possible.

When a battery separator comprises two or more phases of the first type, each phase of the first type may independently comprise glass fibers having a relatively large average fiber diameter having an average fiber diameter in one or more of the above-referenced ranges.

In some embodiments, a phase of the first type comprises synthetic fibers. In some embodiments, a phase of the first type comprises synthetic fibers that are staple fibers. The staple fibers may be fibers that are cut (e.g., from a filament) or formed as non-continuous discrete fibers to have a particular length or a range of lengths. The staple fibers may comprise fibers that are fibrillated and/or fibers that are unfibrillated. It is also possible for the staple fibers to comprise single component staple fibers (e.g., single component staple fibers that are also binder fibers, single component staple fibers that are not binder fibers) and/or multicomponent staple fibers.

In some embodiments, a phase of the first type comprises an amount of synthetic fibers that makes up greater than 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, greater than or equal to 37.5 wt %, greater than or equal to 40 wt %, or greater than or equal to 42.5 wt % of the phase of the first type. In some embodiments, a phase of the first type comprises an amount of synthetic fibers that makes up less than or equal to 45 wt %, less than or equal to 42.5 wt %, less than or equal to 40 wt %, less than or equal to 37.5 wt %, less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, or less than or equal to 7.5 wt % of the phase of the first type. Combinations of the above-referenced ranges are also possible (e.g., greater than 5 wt % and less than or equal to 45 wt %, greater than or equal to 10 wt % and less than or equal to 35 wt %, or greater than or equal to 15 wt % and less than or equal to 30 wt %). Other ranges are also possible.

When a phase of the first type comprises two or more types of synthetic fibers, each type of synthetic fiber may independently make up an amount of the phase of the first type in one or more of the ranges described above and/or all of the synthetic fibers in the phase of the first type may together make up an amount of the phase of the first type in one or more of the ranges described above. Similarly, when a battery separator comprises two or more phases of the first type, each phase of the first type may independently comprise an amount of any particular type of synthetic fiber in one or more of the ranges described above and/or may comprise a total amount of synthetic fibers in one or more of the ranges described above.

Synthetic fibers included in the phases of the first type described herein may have a suitable average fiber diameter. In some embodiments, a phase of the first type comprises synthetic fibers (e.g., non-fibrillated synthetic fibers, non-continuous synthetic fibers, synthetic staple fibers, crimped synthetic fibers, uncrimped synthetic fibers) having an average fiber diameter of greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17 microns, or greater than or equal to 19 microns. In some embodiments, a phase of the first type comprises synthetic fibers having an average fiber diameter of less than or equal to 20 microns, less than or equal to 19 microns, less than or equal to 17 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2 microns, or less than or equal to 1 micron. Combinations of the above-referenced ranges are also possible (e.g., greater than or equal to 1 micron and less than or equal to 20 microns, greater than or equal to 3 microns and less than or equal to 17 microns, or greater than or equal to 5 microns and less than or equal to 15 microns). Other ranges are also possible.

When a phase of the first type comprises two or more types of synthetic fibers, each type of synthetic fiber may independently have an average fiber diameter in one or more of the ranges described above and/or all of the synthetic fibers in the phase of the first type may together have an average fiber diameter in one or more of the ranges described above. In embodiments in which a phase of the first type comprises more than one type of synthetic fiber, each type of synthetic fiber may independently have an average fiber diameter in one or more of the ranges described above and/or all of the synthetic fibers together may have an average fiber diameter in one or more of the ranges described above.

Synthetic fibers present in the phase of the first type may have any of a variety of suitable lengths. In some embodiments, a phase of the first type comprises synthetic fibers having an average fiber length of greater than or equal to 3 mm, greater than or equal to 4 mm, greater than or equal to 5 mm, greater than or equal to 7.5 mm, greater than or equal to 10 mm, greater than or equal to 12.5 mm, greater than or equal to 15 mm, greater than or equal to 17.5 mm, greater than or equal to 20 mm, or greater than or equal to 22.5 mm. In some embodiments, a phase of the first type comprises synthetic fibers having an average fiber length of less than or equal to 25 mm, less than or equal to 22.5 mm, less than or equal to 20 mm, less than or equal to 17.5 mm, less than or equal to 15 mm, less than or equal to 12.5 mm, less than or equal to 10 mm, less than or equal to 7.5 mm, less than or equal to 5 mm, or less than or equal to 4 mm. Combinations of the above-referenced ranges are also possible (e.g., greater than or equal to 3 mm and less than or equal to 25 mm, greater than or equal to 4 mm and less than or equal to 20 mm, or greater than or equal to 5 mm and less than or equal to 15 mm). Other ranges are also possible.

When a phase of the first type comprises two or more types of synthetic fibers, each type of synthetic fiber may independently have an average fiber length in one or more of the ranges described above and/or all of the synthetic fibers in the phase of the first type may together have an average fiber length in one or more of the ranges described above. Similarly, when a battery separator comprises two or more phases of the first type, each phase of the first type may independently comprise one or more types of synthetic fibers having an average fiber length in one or more of the ranges described above and/or may comprise synthetic fibers that overall have an average fiber length in one or more of the ranges described above.

Synthetic fibers included in the phases of the first type described herein may have any of a variety of compositions. Non-limiting examples of suitable materials that may be included in synthetic fibers include poly(ester)s and co-poly(ester)s (e.g., poly(ethylene terephthalate), co-poly(ethylene terephthalate), poly(butylene terephthalate), poly(ethylene isophthalate)), poly(lactic acid), poly(carbonate), poly(amide)s and co-poly(amide)s (e.g., various nylon polymers, various aramid polymers), poly(aramid)s, poly(imide)s, poly(olefin)s (e.g., poly(ethylene), poly(propylene), poly(butylene)), poly(ether ether ketone), poly(acrylic)s (e.g., poly(acrylonitrile), dryspun poly(acrylic)), poly(vinyl alcohol), regenerated cellulose (e.g., synthetic cellulose such cellulose acetate, rayon), halogenated and/or fluorinated polymers (e.g., poly(vinylidene difluoride) (PVDF), poly(tetrafluoroethylene)), copolymers of poly(ethylene) and PVDF, poly(ether sulfone)s, epoxy, phenolic resin, and melamine. Such polymers may be present as pure materials and/or as blends (e.g., with one or more other polymers also listed). Additionally, phases of the first type may comprise monocomponent synthetic fibers and/or multicomponent synthetic fibers. For multicomponent synthetic fibers, each component may independently include one or more of the polymers listed above.

When a battery separator comprises two or more phases of the first type, each phase of the first type may independently comprise some or all of the above types of synthetic fibers.

In some embodiments, a phase of the first type comprises multicomponent fibers (e.g., multicomponent synthetic fibers). The multicomponent fibers may comprise bicomponent fibers (i.e., fibers including two components), may comprise tricomponent fibers (i.e., fibers including three components), and/or may comprise fibers comprising four or more components. In some such embodiments, the multicomponent fibers may include one type of multicomponent fibers (e.g., exclusively one type of bicomponent fibers, exclusively one type of tricomponent fibers) or more than one type of multicomponent fibers (e.g., both bicomponent fibers and tricomponent fibers, two types of bicomponent fibers, two types of tricomponent fibers). In some such embodiments, a phase of the first type comprises multicomponent fibers that serve as a binder that binds fibers within the phase of the first type together. The multicomponent fibers may be present in any appropriate amount and/or have any appropriate dimensions (e.g., fiber diameter and/or length), such as being present in one or more of the amounts and/or having one or more of the dimensions as described above with respect to synthetic fibers.

Multicomponent fibers may have a variety of suitable structures. For instance, a phase of the first type may comprise one or more of the following types of bicomponent fibers: core/sheath fibers (e.g., concentric core/sheath fibers, non-concentric core-sheath fibers), segmented pie fibers, side-by-side fibers, tip-trilobal fibers, split fibers, and “island in the sea” fibers. Core-sheath bicomponent fibers may comprise a sheath that has a lower melting point than that of the core. When heated (e.g., during a binding step), the sheath may melt prior to the core, binding the bicomponent fibers together while the core remains solid. In such embodiments, the bicomponent fibers may serve as a binder for a phase of the first type (and/or a phase of the second type).

Non-limiting examples of suitable materials that may be included in multicomponent fibers include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; halogenated polymers such as poly(tetrafluoroethylene); epoxy; phenolic resins; and melamine. Non-limiting examples of suitable pairs of materials that may be included in bicomponent fibers include poly(ethylene)/poly(ester) (e.g., poly(ethylene)/poly(ethylene terephthalate)), poly(propylene)/poly(ester) (e.g., poly(propylene)/poly(ethylene terephthalate)), co-poly(ester)/poly(ester) (e.g., co-poly(ethylene terephthalate)/poly(ethylene terephthalate)), poly(butylene terephthalate)/poly(ethylene terephthalate), co-poly(amide)/poly(amide), poly(amide)/poly(propylene), and poly(ethylene)/poly(propylene). In the preceding list, the material having the lower melting point is listed first and the material having the higher melting point is listed second. Core-sheath bicomponent fibers comprising one of the above such pairs may have a sheath comprising the first material and a core comprising the second material. In one set of embodiments, core-sheath bicomponent fibers may comprise a core that comprises a thermoset polymer and a sheath that comprises a thermoplastic polymer.

The multicomponent fibers described herein may comprise components having a variety of suitable melting points. In some embodiments, a multicomponent fiber comprises a component having a melting point of greater than or equal to 70° C., greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., greater than or equal to 220° C., greater than or equal to 250° C., greater than or equal to 300° C., greater than or equal to 250° C., greater than or equal to 300° C., greater than or equal to 350° C., or greater than or equal to 400° C. In some embodiments, a multicomponent fiber comprises a component having a melting point of less than or equal to 450° C., less than or equal to 400° C., less than or equal to 350° C., less than or equal to 300° C., less than or equal to 250° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., less than or equal to 90° C., or less than or equal to 80° C. Combinations of the above-referenced ranges are also possible (e.g., greater than or equal to 70° C. and less than or equal to 450° C., greater than or equal to 80° C. and less than or equal to 450° C., greater than or equal to 80° C. and less than or equal to 230° C., or greater than or equal to 110° C. and less than or equal to 230° C.). Other ranges are also possible. In some embodiments, a multicomponent fiber comprises a component having a melting point of less than or equal to 100° C.

The melting point of the components of a multicomponent fiber may be determined by performing differential scanning calorimetry (DSC) according to standard ASTM D3418 (2015).

Each component of a multicomponent fiber may independently have a melting point in one or more of the above-referenced ranges. Multicomponent fibers may comprise exclusively components having the same melting point, exclusively components having different melting points, or at least one pair of components that have the same melting point and at least one pair of components that have different melting points.

In some embodiments, a multicomponent fiber comprises two components that have melting points that differ by greater than or equal to 50° C., greater than or equal to 75° C., greater than or equal to 100° C., greater than or equal to 125° C., greater than or equal to 150° C., greater than or equal to 175° C., greater than or equal to 200° C., greater than or equal to 225° C., greater than or equal to 250° C., greater than or equal to 275° C., greater than or equal to 300° C., greater than or equal to 325° C., or greater than or equal to 350° C. In some embodiments, a multicomponent fiber comprises two components that have melting points that differ by less than or equal to 380° C., less than or equal to 350° C., less than or equal to 325° C., less than or equal to 300° C., less than or equal to 275° C., less than or equal to 250° C., less than or equal to 225° C., less than or equal to 200° C., less than or equal to 175° C., less than or equal to 150° C., less than or equal to 125° C., less than or equal to 100° C., or less than or equal to 75° C. Combinations of the above-referenced ranges are also possible (e.g., greater than or equal to 50° C. and less than or equal to 75° C.). Other ranges are also possible.

In some embodiments, a phase of the first type may include other fiber types than those described above. For instance, any of a variety of other fiber types (e.g., natural fibers such as cellulose fibers and/or regenerated cellulose fibers (e.g., lyocell)) may be included in a phase of the first type. Alternatively or additionally, one or more additives (e.g., inorganic particles) may be incorporated into a phase of the first type described herein. For instance, a fiber web may comprise rubber particles (i.e., particles comprising a rubber), sulfate salt particles (i.e., particles comprising a sulfate salt), and/or other types of inorganic particles (i.e., particles comprising an inorganic compound other than a sulfate salt).

In some embodiments, a binder resin is present in a phase of the first type. Advantageously, the presence of binder resin may lead to enhanced mechanical robustness and strength (e.g., flexibility, puncture strength, tensile strength, etc.) in the phase of the first type described herein. For example, the binder resin may assist with holding fibers together and/or preventing disintegration of a phase of the first type from in the presence of an acid (e.g., sulfuric acid). For example, as described below, the binder resin may an acid-stable resin that is substantially stable in an acid during battery operation.

In some embodiments, a phase of the first type comprises binder resin in an appreciable amount. In some embodiments, a binder resin makes up greater than or equal to 2 wt %, greater than or equal to 3 wt %, greater than or equal to 5 wt %, greater than or equal to 7 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, or greater than or equal to 27.5 wt % a phase of the first type. In some embodiments, a binder resin makes up less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7 wt %, less than or equal to 5 wt %, or less than or equal to 3 wt % of a phase of the first type. Combinations of the above-referenced ranges are also possible (e.g., greater than or equal to 2 wt % and less than or equal to 30 wt %, greater than or equal to 5 wt % and less than or equal to 25 wt %, or greater than or equal to 7 wt % and less than or equal to 20 wt %).

When a phase of the first type comprises two or more types of binder resin, each type of binder resin may independently make up an amount of the phase of the first type in one or more of the ranges described above and/or all of the binder resin in a phase of the first type may together make up an amount of the phase of the first type in one or more of the ranges described above. Similarly, when an article comprises two or more phases of the first type, each phase of the first type may independently comprise an amount of any particular type of binder resin in one or more of the ranges described above and/or may comprise a total amount of binder resin in one or more of the ranges described above. In some embodiments, the binder resin is an acid-stable binder resin. The term “acid-stable”, as used herein, refers to a binder resin that is relatively stable (e.g., unreactive) in the presence of an acid (e.g., sulfuric acid with a specific gravity (spg) of 1.285) for a period of time. Advantageously, the use of an acid-stable binder resin allows the binder resin to retain its ability to bind fibers in the phases and/or separator together such that the phases and/or separator do not lose their structural integrity when exposed to an acid for a period of time. In some embodiments, the resin may be stable for at least 3 weeks (e.g., at least 4 weeks, at least 5 weeks, at least 6 weeks, etc.) when immersed in sulfuric acid at 70° C.

The acid stability of a binder resin can be determined using the following method. A 1 g film of which the binder resin makes up 100 wt % may be created by casting from an aqueous fluid. The binder resin film may be immersed in 100 mL of a 1.285 spg H₂SO₄ acid solution and then the acid-immersed binder resin film may be stored in an oven at 70° C. After the appropriate period of time, the binder resin film can be filtered under vacuum and then rinsed thoroughly with water. The water in the binder resin film can be subsequently dried off by heating the binder resin in an oven at 100° C., after which the weight of the binder resin can be measured and compared to its original weight prior to acid storage. If the weight of the binder resin after acid storage is smaller than the weight of the binder resin before acid storage by less than 2%, the binder resin is considered to be an acid-stable binder resin. If the weight of the binder resin is smaller than the weight of the binder resin before acid storage by greater than or equal to 2%, the binder resin is not considered to be an acid-stable binder resin.

When a battery separator comprises two or more phases of the first type, each phase of the first type may independently comprise some or all of the above types of binder resins.

Binder resins (e.g., acid-stable binder resins) may have a variety of suitable compositions. In some embodiments, a phase of the first type comprises a binder resin (e.g., a non-fibrous resin). The binder resin may comprise a polymer, such as poly(ethylene), poly(propylene), a poly(acrylate) and/or acrylic, a copolymer of styrene and acrylate, styrene butyl acrylate, styrene butadiene, a phenolic-formaldehyde-resorcinol resin, acrylonitrile rubber, melamine-formaldehyde, and/or poly(urethane). In some embodiments, a phase of the first type comprises a resin that is a latex (e.g., an acrylic latex).

The phases of the first type described herein may have any of a variety of suitable basis weights. In some embodiments, a phase of the first type has a basis weight of greater than or equal to 30 gsm, greater than or equal to 35 gsm, greater than or equal to 40 gsm, greater than or equal to 45 gsm, greater than or equal to 50 gsm, greater than or equal to 60 gsm, greater than or equal to 70 gsm, greater than or equal to 80 gsm, greater than or equal to 90 gsm, greater than or equal to 100 gsm, greater than or equal to 110 gsm, greater than or equal to 120 gsm, greater than or equal to 130 gsm, or greater than or equal to 140 gsm. In some embodiments, a phase of the first type has a basis weight of less than or equal to 150 gsm, less than or equal to 140 gsm, less than or equal to 130 gsm, less than or equal to 120 gsm, less than or equal to 110 gsm, less than or equal to 100 gsm, less than or equal to 90 gsm, less than or equal to 80 gsm, less than or equal to 70 gsm, less than or equal to 60 gsm, less than or equal to 50 gsm, less than or equal to 45 gsm, less than or equal to 40 gsm, or less than or equal to 35 gsm. Combinations of the above-referenced ranges are also possible (e.g., greater than or equal to 30 gsm and less than or equal to 150 gsm, greater than or equal to 40 gsm and less than or equal to 130 gsm, or greater than or equal to 50 gsm and less than or equal to 100 gsm). Other ranges are also possible.

The basis weight of a phase of the first type may be determined in accordance with ISO 536:2012.

When a battery separator comprises two or more phases of the first type, each phase of the first type may independently have a basis weight in one or more of the above-referenced ranges.

The phases of the first type described herein may have any of a variety of suitable thicknesses. In some embodiments, a phase of the first type has a thickness of greater than or equal to 200 microns, greater than or equal to 250 microns, greater than or equal to 300 microns, greater than or equal to 350 microns, greater than or equal to 400 microns, greater than or equal to 450 microns, greater than or equal to 500 microns, greater than or equal to 550 microns, greater than or equal to 600 microns, greater than or equal to 650 microns, greater than or equal to 700 microns, greater than or equal to 750 microns, greater than or equal to 800 microns, greater than or equal to 850 microns, greater than or equal to 900 microns, greater than or equal to 950 microns, greater than or equal to 1000 microns, greater than or equal to 1050 microns, greater than or equal to 1100 microns, or greater than or equal to 1150 microns. In some embodiments, a phase of the first type has a thickness of less than or equal to 1200 microns, less than or equal to 1150 microns, less than or equal to 1100 microns, less than or equal to 1050 microns, less than or equal to 1000 microns, less than or equal to 950 microns, less than or equal to 900 microns, less than or equal to 850 microns, less than or equal to 800 microns, less than or equal to 750 microns, less than or equal to 700 microns, less than or equal to 650 microns, less than or equal to 600 microns, less than or equal to 550 microns, less than or equal to 500 microns, less than or equal to 450 microns, less than or equal to 400 microns, less than or equal to 350 microns, less than or equal to 300 microns, or less than or equal to 250 microns. Combinations of the above-referenced ranges are also possible (e.g., greater than or equal to 200 microns and less than or equal to 1200 microns, greater than or equal to 300 microns and less than or equal to 900 microns, or greater than or equal to 400 microns and less than or equal to 800 microns). Other ranges are also possible.

In embodiments in which a well-defined boundary is present between a phase of the first type and any adjacent phases and/or layers, the thickness of a phase of the first type can be determined from high-resolution SEM micrographs acquired on cross-sections of a separator.

In embodiments in which a phase of the first type is separated from another phase or layer by a boundary that is not well-defined (e.g., a rough boundary) and/or in embodiments in which a transition phase is present between a phase of the first type and at least one adjacent phase and/or layer, the location of the boundary between the phase of the first type and the other phase or layer to which it is adjacent may be determined using a density gradient profile measurement. Then, the thickness of the phase of the first type may be calculated based on that measured boundary. The density gradient profile measurement may comprise determining the apparent density (i.e., the ratio of the basis weight to the thickness) of the article comprising the phase of the first type (e.g., a battery separator) as a function of depth. If a change in apparent density is observed, the region over which the apparent density changes may be considered to be a transition phase. The point in the transition phase at which the apparent density is midway between the apparent densities of the phases between which the transition phase is positioned may be considered to be the boundary between those phases for the thickness calculation. This measurement may be taken by various equipment capable of accurately measuring apparent density, such as a QTRS Tree ring scanner and data analyzer model no. QTRS-01X (Quintek Measurement Systems, Knoxville, Tenn.).

When a battery separator comprises two or more phases of the first type, each phase of the first type may independently have a thickness in one or more of the above-referenced ranges.

A phase of the first type may have any of a variety of suitable porosities. In some embodiments, the phase of the first type may have a relatively high porosity. In some embodiments, a phase of the first type has a porosity of greater than or equal to 80%, greater than or equal to 81%, greater than or equal to 82%, greater than or equal to 83%, greater than or equal to 84%, greater than or equal to 85%, greater than or equal to 86%, greater than or equal to 87%, greater than or equal to 88%, greater than or equal to 89%, greater than or equal to 90%, greater than or equal to 91%, greater than or equal to 92%, greater than or equal to 93%, greater than or equal to 94%, greater than or equal to 95%, greater than or equal to 96%, or greater than or equal to 97%. In some embodiments, a phase of the first type has a porosity of less than or equal to 98%, less than or equal to 97%, less than or equal to 96%, less than or equal to 95%, less than or equal to 94%, less than or equal to 93%, less than or equal to 92%, less than or equal to 91%, less than or equal to 90%, less than or equal to 89%, less than or equal to 88%, less than or equal to 87%, less than or equal to 85%, less than or equal to 84%, less than or equal to 83%, less than or equal to 82%, or less than or equal to 81%. Combinations of the above-referenced ranges are also possible (e.g., greater than or equal to 80% and less than or equal to 98%, greater than or equal to 88% and less than or equal to 96%, or greater than or equal to 90% and less than or equal to 95%). Other ranges are also possible.

The porosity of a phase of the first type is equivalent to 100%−[solidity of the phase of the first type]. The solidity of a phase of the first type is equivalent to the percentage of the interior of the phase of the first type occupied by solid material. One non-limiting way of determining solidity of a phase of the first type is described in this paragraph, but other methods are also possible. The method described in this paragraph includes determining the basis weight and thickness of the phase of the first type and then applying the following formula: solidity=[basis weight of the phase of the first type/(density of the components forming the phase of the first type thickness of the phase of the first type)]·100%. The density of the components forming the phase of the first type is equivalent to the average density of the material or material(s) forming the components of the phase of the first type (e.g., the fibers therein, any other components therein), which is typically specified by the manufacturer of each material. The average density of the materials forming the components of the phase of the first type may be determined by: (1) determining the total volume of all of the components in the phase of the first type; and (2) dividing the total mass of all of the components in the phase of the first type by the total volume of all of the components in the phase of the first type. If the mass and density of each component of the phase of the first type are known, the volume of all the components in the phase of the first type may be determined by: (1) for each type of component, dividing the total mass of the component in the phase of the first type by the density of the component; and (2) summing the volumes of each component. If the mass and density of each component of the phase of the first type are not known, the volume of all the components in the phase of the first type may be determined in accordance with Archimedes' principle.

A phase of the first type may have any of a variety of suitable air permeabilities. In some embodiments, a phase of the first type may have relatively low values of air permeability. In some embodiments, a phase of the first type has an air permeability of greater than or equal to 5 cfm/sf (CFM), greater than or equal to 6 CFM, greater than or equal to 7 CFM, greater than or equal to 8 CFM, greater than or equal to 9 CFM, greater than or equal to 10 CFM, greater than or equal to 12.5 CFM, greater than or equal to 15 CFM, greater than or equal to 17.5 CFM, greater than or equal to 20 CFM, greater than or equal to 22.5 CFM, greater than or equal to 25 CFM, or greater than or equal to 27.5 CFM. In some embodiments, a phase of the first type has an air permeability of less than or equal to 30 CFM, less than or equal to 27.5 CFM, less than or equal to 25 CFM, less than or equal to 22.5 CFM, less than or equal to 20 CFM, less than or equal to 17.5 CFM, less than or equal to 15 CFM, less than or equal to 12.5 CFM, less than or equal to 10 CFM, greater than or equal to 9 CFM, less than or equal to 8 CFM, less than or equal to 7 CFM, or less than or equal to 6 CFM. Combinations of the above-referenced ranges are also possible (e.g., greater than or equal to 5 CFM and less than or equal to 30 CFM, greater than or equal to 7 CFM and less than or equal to 25 CFM, greater than or equal to 10 CFM and less than or equal to 20 CFM). Other ranges are also possible.

The air permeability of a phase of the first type may be determined in accordance with ASTM D737-04 (2016) at a pressure of 125 Pa.

When a battery separator comprises two or more phases of the first type, each phase of the first type may independently have an air permeability in one or more of the above-referenced ranges.

The phases of the first type described herein may have any of a variety of suitable mean flow pore sizes. In some embodiments, a phase of the first type has a relatively low value of mean flow pore size. In some embodiments, the mean flow pore size of a phase of the first type is greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, or greater than or equal to 14 microns. In some embodiments, the mean flow pore size of a phase of the first type is less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, less than or equal to 6 microns, less than or equal to 5 microns, less than or equal to 4 microns, less than or equal to 3 microns, or less than or equal to 2 microns. Combinations of the above-referenced ranges are also possible (e.g., greater than or equal to 2 microns and less than or equal to 15 microns, greater than or equal to 3 microns and less than or equal to 12 microns, or greater than or equal to 4 microns and less than or equal to 10 microns). Other ranges are also possible.

The mean flow pore size of a phase of the first type may be determined in accordance with ASTM F316 (2003).

When an article comprises two or more phases of the first type, each phase of the first type may independently have a mean flow pore size in one or more of the above-referenced ranges.

In some embodiments, a battery separator may comprise a phase of a second type. As described above, a phase of the second type may have certain properties that differ from a phase of the first type. For example, compared to a phase of the first type, a phase of the second type may comprise a certain combination of fibers that imparts the phase different physical properties (e.g., larger mean flow pore size, larger air permeabilities, etc.) from a phase of the first type.

As noted previously, a phase of the second type may have a more open pore structure compared to a phase of the first type. Advantageously, a battery separator (e.g., an electrically insulated but ionically conductive separator) comprising a phase of the second type may exhibit reduced ionic resistance as a result of the open pore structure within the phase of the second type. In some embodiments, an open pore structure in a phase of the second type may promote efficient acid filling.

In some embodiments, a phase of the second type may provide one or more advantages typically associated with ribs without incurring one or more drawbacks that may be associated with the use of ribs. As an example, in some embodiments, battery separators including a phase of the second type may apply relatively even pressure to the battery plates while still providing an open structure, thereby not incurring the disadvantageous uneven pressure distribution associated with some ribbed battery separators. Without wishing to be bound by theory, it is believed that an uneven pressure distribution is particularly disadvantageous during cycling, a process in which the battery plates undergo a series of expansions and contractions. An uneven pressure distribution may cause such expansion and contraction to be uneven, which may cause inefficient utilization of the electroactive material in such battery plates. By contrast, a battery separator that is relatively planar (e.g., flat) and/or that comprises a relatively planar surface (e.g., a surface of a phase of the second type) adjacent the battery plates may advantageously apply a relatively more even pressure distribution to thereto during the series of expansions and contractions. This more even pressure distribution may cause the battery plates to expand and/or contract more evenly, which may result in more even utilization of the electroactive material therein.

A second drawback associated with ribs that some phases of the second type do not incur is the enhanced tendency for some ribbed battery separators to allow acid stratification in view of the open volume that they contribute to the battery. In some embodiments, a phase of the second type, while including an appreciable amount of open volume, may result in the battery in which they are positioned having less open volume than an otherwise-equivalent battery separator instead including ribs. This reduction in open volume may assist with preventing and/or reducing acid stratification in comparison to ribbed battery separators. Additionally, as described elsewhere herein, a phase of the second type may comprise one or more hydrophilic materials (e.g., microglass fibers) that may retard acid and/or water diffusion. Either or both of these properties may reduce the acid stratification present in the battery in comparison to an otherwise-equivalent battery separator instead including ribs.

Despite the above discussion, it should also be noted that some battery separators described herein may comprise both ribs and a phase of the second type.

A phase of the second type may comprise fibers having any of a variety of suitable average fiber diameters. In some embodiments, a phase of the second type comprises fibers having an average fiber diameter that is greater than the average fiber diameters of fibers in a phase of the first type.

In some embodiments, a phase of the second type comprises fibers having an average fiber diameter of greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, or greater than or equal to 19 microns. In some embodiments, a phase of the second type comprises fibers having an average fiber diameter of less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, less than or equal to 9 microns, less than or equal to 8 microns, less than or equal to 7 microns, or less than or equal to 6 microns. Combinations of the above-referenced ranges are also possible (e.g., greater than or equal to 5 microns and less than or equal to 20 microns, greater than or equal to 8 microns and less than or equal to 17 microns, or greater than or equal to 10 microns and less than or equal to 15 microns). Other ranges are also possible.

When a phase of the second type comprises two or more types of fibers, each type of fiber may independently have an average fiber diameter in one or more of the ranges described above and/or all of the fibers together may have an average fiber diameter in one or more of the ranges described above. Similarly, when a battery separator comprises two or more phases of the second type, each phase of the second type may independently comprise fibers having an average fiber diameter in one or more of the ranges described above and/or may comprise fibers together having an average fiber diameter in one or more of the ranges described above.

In some embodiments, a phase of the second type includes glass fibers. In some embodiments, a phase of the second type comprises two or more types of glass fibers. In some cases, the two or more types of glass fibers may differ in composition (e.g., fiber type) and/or physical properties (e.g., average fiber diameter and/or average fiber length).

In some embodiments, the glass fibers may make up a relatively large amount of a phase of the second type. In some embodiments, glass fibers make up greater than or equal to 40 wt %, greater than 40 wt %, greater than or equal to 45 wt %, greater than or equal to 50 wt %, greater than or equal to 55 wt %, greater than 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of a phase of the second type. Glass fibers may make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, or less than or equal to 45 wt % of a phase of the second type. Combinations of the above-referenced ranges are also possible (e.g., greater than or equal to 40 wt % and less than or equal to 95 wt %, greater than 40 wt % and less than or equal to 95 wt %, greater than or equal to 55 wt % and less than or equal to 85 wt %, or greater than or equal to 70 wt % and less than or equal to 80 wt %). Other ranges are also possible.

When a phase of the second type comprises two or more types of glass fibers, each type of glass fiber may independently make up an amount of the phase of the second type in one or more of the ranges described above and/or all of the glass fibers together may make up an amount of the phase of the second type in one or more of the ranges described above. Similarly, when a battery separator comprises two or more phases of the second type, each phase of the second type may independently comprise an amount of any particular type of glass fiber in one or more of the ranges described above and/or may comprise a total amount of glass fibers in one or more of the ranges described above.

A phase of the second type may comprise glass fibers having a variety of suitable average fiber diameters. In some embodiments, a phase of the second type comprises glass fibers having an average fiber diameter of greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 11 microns, greater than or equal to 12 microns, greater than or equal to 13 microns, greater than or equal to 14 microns, greater than or equal to 15 microns, greater than or equal to 16 microns, greater than or equal to 17 microns, greater than or equal to 18 microns, or greater than or equal to 19 microns. In some embodiments, a phase of the second type comprises glass fibers having an average fiber diameter of less than or equal to 20 microns, less than or equal to 19 microns, less than or equal to 18 microns, less than or equal to 17 microns, less than or equal to 16 microns, less than or equal to 15 microns, less than or equal to 14 microns, less than or equal to 13 microns, less than or equal to 12 microns, less than or equal to 11 microns, less than or equal to 10 microns, than or equal to 9 microns, less than or equal to 8 microns, less than or equal to 7 microns, less than or equal to 6 microns, or less than or equal to 5 microns. Combinations of the above-referenced ranges are also possible (e.g., greater than or equal to 4 microns and less than or equal to 20 microns, greater than or equal to 6 microns and less than or equal to 18 microns, or greater than or equal to 8 micron and less than or equal to 16 microns). Other ranges are also possible.

When a phase of the second type comprises two or more types of glass fibers, each type of glass fiber may independently have an average fiber diameter in one or more of the ranges described above and/or all of the glass fibers together may together have an average fiber diameter in one or more of the ranges described above. Similarly, when a battery separator comprises two or more phases of the second type, each phase of the second type may independently comprise glass fibers having an average fiber diameter in one or more of the ranges described above and/or may comprise glass fibers together having an average fiber diameter in one or more of the ranges described above.

In some embodiments, a phase of the second type comprises microglass fibers. The microglass fibers may have one or more of the properties described elsewhere herein with respect to a phase of the first type. Similarly, it should be understood that microglass fibers present in a phase of the second type may comprise one or more of the types of microglass fibers described herein with respect to a phase of the first type.

In some embodiments, a phase of the second type comprises one type of microglass fibers having a relatively small average fiber diameter. In some such cases, this type of microglass fibers may have an average fiber diameter in one or more of the ranges as described above with respect to such microglass fibers in a phase of the first type.

In some embodiments, a phase of the second type comprises a relatively low amount of microglass fibers having a relatively small average fiber diameter. In some embodiments, microglass fibers having a relatively small average fiber diameter make up greater than or equal to 0 wt %, greater than or equal to 2.5 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, greater than or equal to 37.5 wt %, greater than or equal to 40 wt %, greater than or equal to 42.5 wt %, greater than or equal to 45 wt %, or greater than or equal to 47.5 wt % of a phase of the second type. Microglass fibers having a relatively small average fiber diameter may make up less than or equal to 50 wt %, less than or equal to 47.5 wt %, less than or equal to 45 wt %, less than or equal to 42.5 wt %, less than or equal to 40 wt %, less than or equal to 37.5 wt %, less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, or less than or equal to 2.5 wt % of a phase of the second type. Combinations of the above-referenced ranges are also possible (e.g., greater than or equal to 0 wt % and less than or equal to 50 wt %, greater than or equal to 2.5 wt % and less than or equal to 30 wt %, or greater than or equal to 5 wt % and less than or equal to 20 wt %). Other ranges are also possible.

When a battery separator comprises two or more phases of the second type, each phase of the second type may independently comprise an amount of microglass fiber having a relatively small average diameter in one or more of the ranges described above and/or may comprise a total amount of such microglass fibers in one or more of the ranges described above.

In some embodiments, a phase of the second type may comprise one type of microglass fibers having a relatively large average fiber diameter. In some cases, this type of microglass fibers may have an average fiber diameter in one or more of the ranges as described above with respect to such microglass fibers in a phase of the first type.

In some embodiments, a phase of the second type comprises an appreciable number of microglass fibers having a relatively large average fiber diameter. In some embodiments, microglass fibers having a relatively large average fiber diameter make up greater than or equal to 40 wt %, greater than 40 wt %, greater than or equal to 45 wt %, greater than or equal to 50 wt %, greater than or equal to 55 wt %, greater than 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of a phase of the second type. Microglass fibers having a relatively large average fiber diameter may make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, or less than or equal to 45 wt % of a phase of the second type. Combinations of the above-referenced ranges are also possible (e.g., greater than or equal to 40 wt % and less than or equal to 95 wt %, greater than 40 wt % and less than or equal to 95 wt %, greater than or equal to 55 wt % and less than or equal to 85 wt %, or greater than or equal to 70 wt % and less than or equal to 80 wt %). Other ranges are also possible.

When a battery separator comprises two or more phases of the second type, each phase of the second type may independently comprise an amount of microglass fibers having a relatively large average fiber diameter in one or more of the above-referenced ranges.

In some embodiments, a phase of the second type comprises chopped strand glass fibers. The chopped strand glass fibers may comprise chopped strand glass fibers having one or more of the properties described herein with respect to a phase of the first type. Similarly, it should be understood that chopped strand glass fibers present in a phase of the second type may comprise one or more of the types of chopped strand glass fibers described herein with respect to a phase of the first type.

A phase of the second type may comprise chopped strand glass fibers in variety of suitable amounts. In some embodiments, chopped strand glass fibers make up greater than or equal to 5 wt %, greater than or equal to 6 wt %, greater than or equal to 7 wt %, greater than or equal to 8 wt %, greater than or equal to 9 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 35 wt %, greater than or equal to 40 wt %, or greater than or equal to 45 wt % of a phase of the second type. In some embodiments, chopped strand glass fibers make up less than or equal to 50 wt %, less than or equal to 45 wt %, less than or equal to 40 wt %, less than or equal to 35 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 9 wt %, less than or equal to 8 wt %, less than or equal to 7 wt %, or less than or equal to 6 wt % of a phase of the second type. Combinations of the above-referenced ranges are also possible (e.g., greater than or equal to 5 wt % and less than or equal to 50 wt %, greater than or equal to 8 wt % and less than or equal to 40 wt %, or greater than or equal to 10 wt % and less than or equal 30 wt %). Other ranges are also possible.

When a phase of the second type comprises two or more types of chopped strand glass fibers, each type of chopped strand glass fiber may independently make up an amount of the phase of the second type in one or more of the ranges described above and/or all of the chopped strand glass fibers in a phase of the second type may together make up an amount of the phase of the second type in one or more of the ranges described above. Similarly, when a battery separator comprises two or more phases of the second type, each phase of the second type may independently comprise an amount of any particular type of chopped strand glass fibers in an amount in one or more of the ranges described above and/or may comprise a total amount of chopped strand glass fibers in one or more of the ranges described above.

Chopped strand glass fibers present in phases of the second type may have a variety of suitable average fiber diameters and/or average fiber lengths. In some embodiments, a phase of the second type comprises chopped strand glass fibers having an average fiber diameter and/or an average fiber length in one or more of the ranges described herein with respect to the chopped strand glass fibers present in phases of the first type.

In some embodiments, a phase of the second type comprises one type of glass fiber that has a relatively small average fiber diameter. The fibers having a relatively small average fiber diameter may comprise microglass fibers.

In some embodiments, a phase of the second type comprises a relatively low amount of glass fibers having a relatively small average fiber diameter. In some embodiments, the glass fibers having the relatively small average fiber diameter make up greater than or equal to 0 wt %, greater than or equal to 1 wt %, greater than or equal to 3 wt %, greater than or equal to 5 wt %, greater than or equal to 6 wt %, greater than or equal to 8 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, greater than or equal to 37.5 wt %, greater than or equal to 40 wt %, greater than or equal to 42.5 wt %, greater than or equal to 45 wt %, or greater than or equal to 47.5 wt % of a phase of the second type. Glass fibers having a relatively small average fiber diameter may make up less than or equal to 50 wt %, less than or equal to 47.5 wt %, less than or equal to 45 wt %, less than or equal to 42.5 wt %, less than or equal to 40 wt %, less than or equal to 37.5 wt %, less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 8 wt %, less than or equal to 6 wt %, less than or equal to 5 wt %, less than or equal to 3 wt %, or less than or equal to 1 wt % of a phase of the second type. Combinations of the above-referenced ranges are also possible (e.g., greater than or equal to 0 wt % and less than or equal to 50 wt %, greater than or equal to 5 wt % and less than or equal to 40 wt %, greater than or equal to 8 wt % and less than or equal to 30 wt %, or greater than or equal to 10 wt % and less than or equal to 20 wt %). Other ranges are also possible.

When a battery separator comprises two or more phases of the second type, each phase of the second type may independently comprise an amount of glass fibers having a relatively small average fiber diameter in one or more of the above-referenced ranges.

Glass fibers having a relatively small average fiber diameter may have an average fiber diameter of greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, greater than or equal to 2.75 microns, greater than or equal to 3 microns, greater than or equal to 3.5 microns, greater than or equal to 4 microns, or greater than or equal to 4.5 microns. Glass fibers having a relatively small average fiber diameter may have an average fiber diameter of less than or equal to 5 microns, less than or equal to 4.5 microns, less than or equal to 4 microns, less than or equal to 3.5 microns, less than or equal to 3 microns, less than or equal to 2.75 microns, less than or equal to 2.5 microns, less than or equal to 2.25 microns, less than or equal to 2 microns, less than or equal to 1.75 microns, less than or equal to 1.5 microns, less than or equal to 1.25 microns, less than or equal to 1 micron, less than or equal to 0.9 microns, less than or equal to 0.8 microns, less than or equal to 0.7 microns, or less than or equal to 0.6 microns. Combinations of the above-referenced ranges are also possible (e.g., greater than or equal to 0.5 microns and less than or equal to 5 microns, greater than or equal to 0.8 microns and less than or equal to 3 microns, greater than or equal to 1 micron and less than or equal to 2 microns). Other ranges are also possible.

When a battery separator comprises two or more phases of the second type, each phase of the second type may independently comprise glass fibers having a relatively small average fiber diameter having an average fiber diameter in one or more of the above-referenced ranges.

In some embodiments, a phase of the second type comprises an appreciable number of glass fibers having a relatively large average fiber diameter. Such fibers may comprise chopped strand glass fibers. In some embodiments, glass fibers having a relatively large average fiber diameter make up greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of a phase of the second type. Glass fibers having a relatively large average fiber diameter may make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, or less than or equal to 10 wt % of a phase of the second type. Combinations of the above-referenced ranges are also possible (e.g., greater than or equal to 5 wt % and less than or equal to 95 wt %, greater than or equal to 40 wt % and less than or equal to 95 wt %, greater than or equal to 55 wt % and less than or equal to 85 wt %, or greater than or equal to 70 wt % and less than or equal to 80 wt %). Other ranges are also possible.

When a battery separator comprises two or more phases of the second type, each phase of the second type may independently comprise an amount of glass fibers having a relatively large average fiber diameter in one or more of the above-referenced ranges.

Glass fibers having a relatively large average fiber diameter may have an average fiber diameter of greater than 5 microns, greater than or equal to 5.5 microns, greater than or equal to 6 microns, greater than or equal to 6.5 microns, greater than or equal to 7 microns, greater than or equal to 7.5 microns, greater than or equal to 8 microns, greater than or equal to 8.5 microns, greater than or equal to 9 microns, greater than or equal to 10 microns, greater than or equal to 11 microns, greater than or equal to 13 microns, greater than or equal to 15 microns, greater than or equal to 17 microns, or greater than or equal to 19 microns. Glass fibers having a relatively large average fiber diameter may have an average fiber diameter of less than or equal to 20 microns, less than or equal to 19 microns, less than or equal to 17 microns, less than or equal to 15 microns, less than or equal to 13 microns, less than or equal to 11 microns, less than or equal to 10 microns, less than or equal to 9.5 microns, less than or equal to 9 microns, less than or equal to 8.5 microns, less than or equal to 8 microns, less than or equal to 7.5 microns, less than or equal to 7 microns, less than or equal to 6.5 microns, less than or equal to 6 microns, or less than or equal to 5.5 microns. Combinations of the above-referenced ranges are also possible (e.g., greater than 5 microns and less than or equal to 20 microns, greater than or equal to 6 microns and less than or equal to 17 microns, greater than or equal to 7 microns and less than or equal to 15 microns). Other ranges are also possible.

When a battery separator comprises two or more phases of the second type, each phase of the second type may independently comprise glass fibers having a relatively large average fiber diameter having an average fiber diameter in one or more of the above-referenced ranges.

In some embodiments, a phase of the second type comprises synthetic fibers. In some embodiments, a phase of the second type comprises synthetic fibers that are staple fibers. The staple fibers may comprise fibers that are fibrillated and/or fibers that are unfibrillated. It is also possible for the staple fibers to comprise single component staple fibers (e.g., single component staple fibers that are also binder fibers, single component staple fibers that are not binder fibers) and/or multicomponent staple fibers, some, all, or none of which may be as described above with respect to a phase of the first type.

A phase of the second type may comprise any of a variety of suitable amounts of synthetic fibers. For instance, in some embodiments, a phase of the second type comprises an amount of synthetic fibers that makes up greater than 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, greater than or equal to 37.5 wt %, greater than or equal to 40 wt %, or greater than or equal to 42.5 wt % of the phase of the second type. In some embodiments, a phase of the second type comprises an amount of synthetic fibers that makes up less than or equal to 45 wt %, less than or equal to 42.5 wt %, less than or equal to 40 wt %, less than or equal to 37.5 wt %, less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, or less than or equal to 7.5 wt % of the phase of the second type. Combinations of the above-referenced ranges are also possible (e.g., greater than 5 wt % and less than or equal to 45 wt %, greater than or equal to 10 wt % and less than or equal to 35 wt %, or greater than or equal to 15 wt % and less than or equal to 30 wt %). Other ranges are also possible.

When a phase of the second type comprises two or more types of synthetic fibers, each type of synthetic fiber may independently make up an amount of the phase of the second type in one or more of the ranges described above and/or all of the synthetic fibers in a phase of the second type may together make up an amount of the phase of the second type in one or more of the ranges described above. Similarly, when a battery separator comprises two or more phases of the second type, each phase of the second type may independently comprise an amount of any particular type of synthetic fiber in one or more of the ranges described above and/or may comprise a total amount of synthetic fibers in one or more of the ranges described above.

The synthetic fibers present in the layers of the second type described herein may have any of a variety of suitable average fiber diameters and/or average fiber lengths. For instance, such synthetic fibers may have an average fiber diameter and/or an average fiber length in one or more of the ranges described previously with respect to the synthetic fibers that may be included in a phase of the first type.

Similarly, synthetic fibers included in the phase of the second type described herein may have any of a variety of compositions. For instance, such synthetic fibers may have one or more of the compositions described previously with respect to the synthetic fibers that may be included in a phase of the first type.

A phase of the second type may include other fiber types (e.g., natural fibers, fibrillated fibers, binder fibers, etc.) and/or one or more additives (e.g., inorganic particles) in addition to those described above. As an example, a phase of the second type may comprise some, all, or none of the fiber types and/or additives described previously with respect to the phases of the first type.

In some embodiments, a binder resin is present in a phase of the second type. Advantageously, the presence of binder resin may result in enhanced mechanical robustness and strength in the phase of the second type described herein. For example, the binder resin may assist with holding fibers together and/or preventing disintegration of a phase of the second type in a flooded environment comprising an acid (e.g., sulfuric acid). As described above with respective to binder resins included in a phase of the first type, the binder resin may be an acid-stable resin that is substantially stable in an acid for a period of time.

In some embodiments, a phase of the second type comprises binder resin in an appreciable amount. In some embodiments, a binder resin makes up greater than or equal to 2 wt %, greater than or equal to 3 wt %, greater than or equal to 5 wt %, greater than or equal to 7 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, or greater than or equal to 27.5 wt % of a phase of the second type. In some embodiments, a binder resin makes up less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7 wt %, less than or equal to 5 wt %, or less than or equal to 3 wt % of a phase of the second type. Combinations of the above-referenced ranges are also possible (e.g., greater than or equal to 2 wt % and less than or equal to 30 wt %, greater than or equal to 5 wt % and less than or equal to 25 wt %, or greater than or equal to 7 wt % and less than or equal to 20 wt %).

When a phase of the second type comprises two or more types of binder resin, each type of binder resin may independently make up an amount of the phase of the second type in one or more of the ranges described above and/or all of the binder resin in a phase of the second type may together make up an amount of the phase of the second type in one or more of the ranges described above. Similarly, when an article comprises two or more phases of the second type, each phase of the second type may independently comprise an amount of any particular type of binder resin in one or more of the ranges described above and/or may comprise a total amount of binder resin in one or more of the ranges described above.

Binder resins present in the phases of the second type described herein may have a variety of suitable compositions. In some embodiments, a binder resin included in a phase of the second type comprises one or more of the polymers described elsewhere herein as being suitable for the types of binder resins that may be included in the phases of the first type.

A phase of the second type may have any of a variety of suitable basis weights. In some embodiments, the basis weight of a phase of the second type has a relatively high value. In some embodiments, a phase of the second type has a basis weight of greater than or equal to 35 gsm, greater than or equal to 37.5 gsm, greater than or equal to 40 gsm, greater than or equal to 42.5 gsm, greater than or equal to 45 gsm, greater than or equal to 50 gsm, greater than or equal to 75 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 275 gsm, greater than or equal to 300 gsm, greater than or equal to 325 gsm, greater than or equal to 350 gsm, or greater than or equal to 375 gsm. In some embodiments, a phase of the second type has a basis weight of less than or equal to 400 gsm, less than or equal to 375 gsm, less than or equal to 350 gsm, less than or equal to 325 gsm, less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 75 gsm, less than or equal to 50 gsm, less than or equal to 45 gsm, less than or equal to 42.5 gsm, less than or equal to 40 gsm, or less than or equal to 37.5 gsm. Combinations of the above-referenced ranges are also possible (e.g., greater than or equal to 35 gsm and less than or equal to 400 gsm, greater than or equal to 40 gsm and less than or equal to 375 gsm, or greater than or equal to 45 gsm and less than or equal to 350 gsm). Other ranges are also possible.

The basis weight of a phase of the second type may be determined in accordance with ISO 536:2012.

When a battery separator comprises two or more phases of the second type, each phase of the second type may independently have a basis weight in one or more of the above-referenced ranges.

The phases of the second type described herein may have any of a variety of suitable thicknesses. In some embodiments, a phase of the second type has a relatively high thickness. In some embodiments, a phase of the second type has a thickness of greater than or equal to 300 microns, greater than or equal to 350 microns, greater than or equal to 400 microns, greater than or equal to 450 microns, greater than or equal to 500 microns, greater than or equal to 600 microns, greater than or equal to 800 microns, greater than or equal to 1000 microns, greater than or equal to 1250 microns, greater than or equal to 1500 microns, greater than or equal to 1750 microns, greater than or equal to 2000 microns, greater than or equal to 2250 microns, greater than or equal to 2500 microns, greater than or equal to 2600 microns, greater than or equal to 2750 microns, or greater than or equal to 2900 microns. In some embodiments, a phase of the second type has a thickness of less than or equal to 3000 microns, less than or equal to 2900 microns, less than or equal to 2750 microns, less than or equal to 2600 microns, less than or equal to 2500 microns, less than or equal to 2250 microns, less than or equal to 2000 microns, less than or equal to 1750 microns, less than or equal to 1500 microns, less than or equal to 1250 microns, less than or equal to 1000 microns, less than or equal to 800 microns, less than or equal to 600 microns, less than or equal to 500 microns, less than or equal to 450 microns, less than or equal to 400 microns, or less than or equal to 350 microns. Combinations of the above-referenced ranges are also possible (e.g., greater than or equal to 300 microns and less than or equal to 3000 microns, greater than or equal to 350 microns and less than or equal to 2750 microns, or greater than or equal to 400 microns and less than or equal to 2500 microns). Other ranges are also possible.

The thickness of a phase of the second type can be measured using one of the methods described above with respect to the measurement of the thickness of a phase of the first type.

When a battery separator comprises two or more phases of the second type, each phase of the second type may independently have a thickness in one or more of the above-referenced ranges.

A phase of the second type may have any of a variety of suitable porosities. In some embodiments, the phase of the second type has a relatively high porosity. In some embodiments, a phase of the second type has a porosity of greater than or equal to 80%, greater than or equal to 81%, greater than or equal to 82%, greater than or equal to 83%, greater than or equal to 84%, greater than or equal to 85%, greater than or equal to 86%, greater than or equal to 87%, greater than or equal to 88%, greater than or equal to 89%, greater than or equal to 90%, greater than or equal to 91%, greater than or equal to 92%, greater than or equal to 93%, greater than or equal to 94%, greater than or equal to 95%, greater than or equal to 96%, or greater than or equal to 97%. In some embodiments, a phase of the second type has a porosity of less than or equal to 98%, less than or equal to 97%, less than or equal to 96%, less than or equal to 95%, less than or equal to 94%, less than or equal to 93%, less than or equal to 92%, less than or equal to 91%, less than or equal to 90%, less than or equal to 89%, less than or equal to 88%, less than or equal to 87%, less than or equal to 86%, less than or equal to 85%, less than or equal to 84%, less than or equal to 83%, less than or equal to 82%, or less than or equal to 81%. Combinations of the above-referenced ranges are also possible (e.g., greater than or equal to 80% and less than or equal to 98%, greater than or equal to 88% and less than or equal to 96%, or greater than or equal to 90% and less than or equal to 95%). Other ranges are also possible.

The porosity of a phase of the second type may be determined using methods described previously with respect to the determination of the porosity of a phase of the first type.

When a battery separator comprises two or more phases of the second type, each phase of the second type may independently have a porosity in one or more of the above-referenced ranges.

A phase of the second type may have any of a variety of suitable air permeabilities. In some embodiments, the phase of the second type described herein may have a relatively high air permeability. In some embodiments, a phase of the second type has an air permeability of greater than or equal to 50 CFM, greater than or equal to 60 CFM, greater than or equal to 75 CFM, greater than or equal to 90 CFM, greater than or equal to 100 CFM, greater than or equal to 150 CFM, greater than or equal to 200 CFM, greater than or equal to 250 CFM, greater than or equal to 300 CFM, greater than or equal to 350 CFM, greater than or equal to 400 CFM, greater than or equal to 450 CFM, greater than or equal to 500 CFM, or greater than or equal to 550 CFM. In some embodiments, a phase of the second type has an air permeability of less than or equal to 600 CFM, less than or equal to 550 CFM, less than or equal to 500 CFM, less than or equal to 450 CFM, less than or equal to 400 CFM, less than or equal to 350 CFM, less than or equal to 300 CFM, less than or equal to 250 CFM, less than or equal to 200 CFM, less than or equal to 150 CFM, less than or equal to 100 CFM, less than or equal to 90 CFM, less than or equal to 75 CFM, or less than or equal to 60 CFM. Combinations of the above-referenced ranges are also possible (e.g., greater than or equal to 50 CFM and less than or equal to 600 CFM, greater than or equal to 75 CFM and less than or equal to 500 CFM, greater than or equal to 100 CFM and less than or equal to 400 CFM). Other ranges are also possible.

The air permeability of a phase of the second type may be determined in accordance with ASTM D737-04 (2016) at a pressure of 125 Pa.

When a battery separator comprises two or more phases of the second type, each phase of the second type may independently have an air permeability in one or more of the above-referenced ranges.

The phases of the second type described herein may have any of a variety of suitable mean flow pore sizes. In some embodiments, a phase of the second type has a relatively high value of mean flow pore size. In some embodiments, the mean flow pore size of a phase of the second type is greater than or equal to 20 microns, greater than or equal to 25 microns, greater than or equal to 30 microns, greater than or equal to 40 microns, greater than or equal to 50 microns, greater than or equal to 60 microns, greater than or equal to 70 microns, greater than or equal to 80 microns, greater than or equal to 90 microns, greater than or equal to 100 microns, greater than or equal to 110 microns, greater than or equal to 120 microns, greater than or equal to 130 microns, or greater than or equal to 140 microns. In some embodiments, the mean flow pore size of a phase of the second type is less than or equal to 150 microns, less than or equal to 140 microns, less than or equal to 130 microns, less than or equal to 120 microns, less than or equal to 110 microns, less than or equal to 100 microns, less than or equal to 90 microns, less than or equal to 80 microns, less than or equal to 70 microns, less than or equal to 60 microns, less than or equal to 50 microns, less than or equal to 40 microns, less than or equal to 30 microns, or less than or equal to 25 microns. Combinations of the above-referenced ranges are also possible (e.g., greater than or equal to 20 microns and less than or equal to 150 microns, greater than or equal to 25 microns and less than or equal to 120 microns, or greater than or equal to 30 microns and less than or equal to 100 microns). Other ranges are also possible.

The mean flow pore size of a phase of the second type may be determined in accordance with ASTM F316 (2003).

When a battery separator comprises two or more phases of the second type, each phase of the second type may independently have a mean flow pore size in one or more of the above-referenced ranges.

A battery separator may comprise glass fibers in any of a variety of suitable total amounts. In some embodiments, glass fibers make up in total greater than or equal to 40 wt %, greater than 40 wt %, greater than or equal to 45 wt %, greater than or equal to 50 wt %, greater than or equal to 55 wt %, greater than 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, or greater than or equal to 90 wt % of the battery separator. Glass fibers may make up less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 50 wt %, or less than or equal to 45 wt % of the battery separator. Combinations of the above-referenced ranges are also possible (e.g., greater than or equal to 40 wt % and less than or equal to 95 wt %, greater than 40 wt % and less than or equal to 95 wt %, greater than or equal to 55 wt % and less than or equal to 85 wt %, or greater than or equal to 70 wt % and less than or equal to 80 wt %). Other ranges are also possible.

A battery separator may comprise synthetic fibers in any of a variety of suitable total amounts. In some embodiments, synthetic fibers may make up in total greater than 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 27.5 wt %, greater than or equal to 30 wt %, greater than or equal to 32.5 wt %, greater than or equal to 35 wt %, greater than or equal to 37.5 wt %, greater than or equal to 40 wt %, or greater than or equal to 42.5 wt % of the battery separator. In some embodiments, a battery separator comprises an amount of synthetic fibers that make up less than or equal to 45 wt %, less than or equal to 42.5 wt %, less than or equal to 40 wt %, less than or equal to 37.5 wt %, less than or equal to 35 wt %, less than or equal to 32.5 wt %, less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, or less than or equal to 7.5 wt % of the battery separator. Combinations of the above-referenced ranges are also possible (e.g., greater than 5 wt % and less than or equal to 45 wt %, greater than or equal to 10 wt % and less than or equal to 35 wt %, or greater than or equal to 15 wt % and less than or equal to 30 wt %). Other ranges are also possible.

A battery separator may comprise binder resin in any of a variety of suitable total amounts. In some embodiments, a binder resin makes up in total greater than or equal to 2 wt %, greater than or equal to 3 wt %, greater than or equal to 5 wt %, greater than or equal to 7 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, or greater than or equal to 27.5 wt % of a battery separator. In some embodiments, a binder resin makes up less than or equal to 30 wt %, less than or equal to 27.5 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 7 wt %, less than or equal to 5 wt %, or less than or equal to 3 wt % of a battery separator. Combinations of the above-referenced ranges are also possible (e.g., greater than or equal to 2 wt % and less than or equal to 30 wt %, greater than or equal to 5 wt % and less than or equal to 25 wt %, or greater than or equal to 7 wt % and less than or equal to 20 wt %).

The battery separator described herein may have any of a variety of suitable basis weights. In some embodiments, a battery separator has a basis weight of greater than or equal to 65 gsm, greater than or equal to 70 gsm, greater than or equal to 75 gsm, greater than or equal to 80 gsm, greater than or equal to 100 gsm, greater than or equal to 125 gsm, greater than or equal to 150 gsm, greater than or equal to 175 gsm, greater than or equal to 200 gsm, greater than or equal to 225 gsm, greater than or equal to 250 gsm, greater than or equal to 275 gsm, greater than or equal to 300 gsm, greater than or equal to 325 gsm, greater than or equal to 350 gsm, greater than or equal to 375 gsm, greater than or equal to 400 gsm, greater than or equal to 425 gsm, greater than or equal to 450 gsm, greater than or equal to 475 gsm, or greater than or equal to 500 gsm. In some embodiments, a battery separator has a basis weight of less than or equal to 550 gsm, less than or equal to 500 gsm, less than or equal to 475 gsm, less than or equal to 450 gsm, less than or equal to 425 gsm, less than or equal to 400 gsm, less than or equal to 375 gsm, less than or equal to 350 gsm, less than or equal to 325 gsm, less than or equal to 300 gsm, less than or equal to 275 gsm, less than or equal to 250 gsm, less than or equal to 225 gsm, less than or equal to 200 gsm, less than or equal to 175 gsm, less than or equal to 150 gsm, less than or equal to 125 gsm, less than or equal to 100 gsm, less than or equal to 80 gsm, less than or equal to 75 gsm, or less than or equal to 70 gsm. Combinations of the above-referenced ranges are also possible (e.g., greater than or equal to 65 gsm and less than or equal to 550 gsm, greater than or equal to 70 gsm and less than or equal to 450 gsm, or greater than or equal to 80 gsm and less than or equal to 400 gsm). Other ranges are also possible.

The basis weight of a battery separator may be determined in accordance with ISO 536:2012.

As noted above, in some embodiments, the battery separators described herein comprise a phase of the first type and a phase of the second type. In such cases, the battery separator may have any of a variety of appropriate basis weight ratios of the basis weight of the phase of the second type to the basis weight of the phase of the first type. In some embodiments, a battery separator may have a relatively high basis weight ratio, e.g., where the basis weight of the phase of the second type is greater than or equal to the basis weight of the phase of the first type. Advantageously, a battery separator having a relatively high basis weight ratio may exhibit reduced ionic resistance. In battery separators comprising a relatively high basis weight ratio (i.e., a relatively high ratio of the basis weight of the phase of the second type to the basis weight of the phase as a first type), the phase of the second type, which is relatively open, makes up a relatively larger amount of the battery separator than the phase of the first type, which is relatively tight. Accordingly, such battery separators, overall, may have a more open overall pore structure and/or a lower tortuosity than battery separators having a relatively low basis weight ratio. The relatively open pore structure and/or relatively lower tortuosity may allow for enhanced ion transport.

In some embodiments, a ratio of the basis weight of a phase of the second type to the basis weight of a phase of the first type is greater than or equal to 1, greater than or equal to 1.1, greater than or equal to 1.15, greater than or equal to 1.2, greater than or equal to 1.4, greater than or equal to 1.5, greater than or equal to 1.6, greater than or equal to 1.8, greater than or equal to 2, greater than or equal to 2.5, greater than or equal to 3, greater than or equal to 3.5, greater than or equal to 4, greater than or equal to 4.5, greater than or equal to 5, greater than or equal to 5.5, greater than or equal to 6, greater than or equal to 6.5, greater than or equal to 7, greater than or equal to 7.5, greater than or equal to 8, greater than or equal to 8.5, greater than or equal to 9, or greater than or equal to 9.5. In some embodiments, a ratio of the basis weight of a phase of the second type to the basis weight of a phase of the first type is less than or equal to 10, less than or equal to 9.5, less than or equal to 9, less than or equal to 8.5, less than or equal to 8, less than or equal to 7.5, less than or equal to 7, less than or equal to 6.5, less than or equal to 6, less than or equal to 5.5, less than or equal to 5, less than or equal to 4.5, less than or equal to 4, less than or equal to 3.5, less than or equal to 3, less than or equal to 2.5, less than or equal to 2, less than or equal to 1.8, less than or equal to 1.6, less than or equal to 1.5, less than or equal to 1.4, less than or equal to 1.2, less than or equal to 1.15, or less than or equal to 1.1. Combinations of the above-referenced ranges are possible (e.g., greater than or equal to 1 and less than or equal to 10, greater than or equal to 1 and less than or equal to 8, or greater than or equal to 1 and less than or equal to 7). Other ranges are also possible.

If a battery separator comprises two or more phases of the first type and/or two or more phases of the second type, the ratio of the basis weight of each phase of the second type to that of each phase of the first type may independently be in one or more of the above-referenced ranges. Additionally, in such embodiments, the ratio of the sum of the basis weights of the phases of the second type to the sum of the basis weights of the first type may be in one or more of the above-referenced ranges.

The battery separators described herein may have any of a variety of suitable thicknesses. In some embodiments, a battery separator has a thickness of greater than or equal to 500 microns, greater than or equal to 550 microns, greater than or equal to 600 microns, greater than or equal to 650 microns, greater than or equal to 700 microns, greater than or equal to 750 microns, greater than or equal to 800 microns, greater than or equal to 900 microns, greater than or equal to 1000 microns, greater than or equal to 1250 microns, greater than or equal to 1500 microns, greater than or equal to 1750 microns, greater than or equal to 2000 microns, greater than or equal to 2250 microns, greater than or equal to 2500 microns, greater than or equal to 2750 microns, greater than or equal to 3000 microns, greater than or equal to 3250 microns, greater than or equal to 3500 microns, greater than or equal to 3750 microns, or greater than or equal to 4000 microns. In some embodiments, a battery separator has a thickness of less than or equal to 4200 microns, less than or equal to 4000 microns, less than or equal to 3750 microns, less than or equal to 3500 microns, less than or equal to 3250 microns, less than or equal to 3000 microns, less than or equal to 2750 microns, less than or equal to 2500 microns, less than or equal to 2250 microns, less than or equal to 2000 microns, less than or equal to 1750 microns, less than or equal to 1500 microns, less than or equal to 1250 microns, less than or equal to 1000 microns, less than or equal to 900 microns, less than or equal to 800 microns, less than or equal to 750 microns, less than or equal to 700 microns, less than or equal to 650 microns, less than or equal to 600 microns, or less than or equal to 550 microns. Combinations of the above-referenced ranges are also possible (e.g., greater than or equal to 500 microns and less than or equal to 4200 microns, greater than or equal to 700 microns and less than or equal to 4000 microns, or greater than or equal to 800 microns and less than or equal to 3000 microns). Other ranges are also possible.

The thickness of a battery separator may be determined in accordance with ASTM D1777 (2015) under an applied pressure of 0.8 kPa.

As noted above, in some embodiments, the battery separators described herein comprise a phase of the first type and a phase of the second type. In such cases, the battery separator may have a particular ratio of the thickness of the phase of the second type to the thickness of the phase of the first type. In some embodiments, a battery separator may have a relatively high thickness ratio, e.g., where the thickness of the phase of the second type (e.g., an open phase) is greater than the thickness of the phase of the first type (e.g., a tight phase). Battery separators having a relatively high thickness ratio may be advantageous for the same reasons described elsewhere herein that battery separators having a relatively high basis weight ratio may be advantageous.

In some embodiments, a ratio of the thickness of a phase of the second type to the thickness of a phase of the first type within a battery separator is greater than or equal to 1.15, greater than or equal to 1.2, greater than or equal to 1.3, greater than or equal to 1.4, greater than or equal to 1.5, greater than or equal to 1.6, greater than or equal to 1.7, greater than or equal to 1.8, greater than or equal to 1.9, greater than or equal to 2, greater than or equal to 2.25, greater than or equal to 2.5, greater than or equal to 3, greater than or equal to 3.5, greater than or equal to 4, greater than or equal to 4.5, greater than or equal to 5, greater than or equal to 5.5, greater than or equal to 6, greater than or equal to 6.5, greater than or equal to 7, greater than or equal to 7.5, greater than or equal to 8, greater than or equal to 8.5, greater than or equal to 9, or greater than or equal to 9.5. In some embodiments, a battery separator has a ratio of the thickness of a phase of the second type to the thickness of a phase of the first type of less than or equal to 10, less than or equal to 9.5, less than or equal to 9, less than or equal to 8.5, less than or equal to 8, less than or equal to 7.5, less than or equal to 7, less than or equal to 6.5, less than or equal to 6, less than or equal to 5.5, less than or equal to 5, less than or equal to 4.5, less than or equal to 4, less than or equal to 3.5, less than or equal to 3, less than or equal to 2.5, less than or equal to 2.25, less than or equal to 2, less than or equal to 1.9, less than or equal to 1.8, less than or equal to 1.7, less than or equal to 1.6, less than or equal to 1.5, less than or equal to 1.4, less than or equal to 1.3, or less than or equal to 1.2. Combination of the above-referenced ranges are possible (e.g., greater than or equal to 1.15 and less than or equal to 10, greater than or equal to 1.5 and less than or equal to 8, greater than or equal to 2 and less than or equal to 7). Other ranges are also possible.

If a battery separator comprises two or more phases of the first type and/or two or more phases of the second type, the ratio of the thickness of each phase of the second type to that of each phase of the first type may independently be in one or more of the above-referenced ranges. Additionally, in such embodiments, the ratio of the sum of the thicknesses of the phases of the second type to the sum of the thicknesses of the first type may be in one or more of the above-referenced ranges.

The battery separators described herein may have any of a variety of suitable mean flow pore sizes. In some embodiments, a battery separator has a relatively high value of mean flow pore size. In some embodiments, the mean flow pore size of a battery separator is greater than or equal to 3 microns, greater than or equal to 4 microns, greater than or equal to 5 microns, greater than or equal to 6 microns, greater than or equal to 7 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, or greater than or equal to 27.5 microns. In some embodiments, the mean flow pore size of a battery separator is less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 8 microns, less than or equal to 7 microns, less than or equal to 6 microns, less than or equal to 5 microns, or less than or equal to 4 microns. Combinations of the above-referenced ranges are also possible (e.g., greater than or equal to 3 microns and less than or equal to 30 microns, greater than or equal to 4 microns and less than or equal to 20 microns, or greater than or equal to 5 microns and less than or equal to 15 microns). Other ranges are also possible.

The mean flow pore size of a battery separator may be determined in accordance with ASTM F316 (2003).

A battery separator may have any of a variety of suitable apparent densities. The apparent density may be greater than or equal to 100 gsm/mm, greater than or equal to 115 gsm/mm, greater than or equal to 120 gsm/mm, greater than or equal to 125 gsm/mm, greater than or equal to 130 gsm/mm, greater than or equal to 135 gsm/mm, greater than or equal to 140 gsm/mm, greater than or equal to 150 gsm/mm, greater than or equal to 160 gsm/mm, greater than or equal to 170 gsm/mm, or greater than or equal to 185 gsm/mm. The apparent density may be less than or equal to 200 gsm/mm, less than or equal to 185 gsm/mm, less than or equal to 170 gsm/mm, less than or equal to 160 gsm/mm, less than or equal to 150 gsm/mm, less than or equal to 140 gsm/mm, less than or equal to 135 gsm/mm, less than or equal to 130 gsm/mm, less than or equal to 125 gsm/mm, less than or equal to 120 gsm/mm, or less than or equal to 115 gsm/mm. Combinations of the above-referenced ranges are also possible (e.g., greater than or equal to 100 gsm/mm and less than or equal to 200 gsm/mm, greater than or equal to 115 gsm/mm and less than or equal to 185 gsm/mm, or greater than or equal to 130 gsm/mm and less than or equal to 170 gsm/mm). Other ranges are also possible.

The apparent density of a battery separator may be determined by dividing the density of the battery separator by the thickness of the battery separator.

The battery separator described herein may have any of a variety of suitable porosities. In some embodiments, a battery separator may have a relatively high porosity. In some embodiments, a battery separator has a porosity of greater than or equal to 85%, greater than or equal to 86%, greater than or equal to 87%, greater than or equal to 88%, greater than or equal to 89%, greater than or equal to 90%, greater than or equal to 91%, greater than or equal to 92%, greater than or equal to 93%, greater than or equal to 94%, greater than or equal to 95%, greater than or equal to 96%, or greater than or equal to 97%. In some embodiments, a battery separator has a porosity of less than or equal to 98%, less than or equal to 97%, less than or equal to 96%, less than or equal to 95%, less than or equal to 94%, less than or equal to 93%, less than or equal to 92%, less than or equal to 91%, less than or equal to 90%, less than or equal to 89%, less than or equal to 88%, less than or equal to 87%, or less than or equal to 86%. Combinations of the above-referenced ranges are also possible (e.g., greater than or equal to 85% and less than or equal to 98%, greater than or equal to 88% and less than or equal to 96%, or greater than or equal to 90% and less than or equal to 95%). Other ranges are also possible.

The porosity of a battery separator may be determined using methods described elsewhere herein with respect to the determination of the porosity of a phase of the first type.

The battery separator described herein may any of a variety of suitable puncture strengths. In some embodiments, a battery separator has a puncture strength of greater than or equal to 6 N, greater than or equal to 7 N, greater than or equal to 8 N, greater than or equal to 9 N, greater than or equal to 10 N, greater than or equal to 12.5 N, greater than or equal to 15 N, greater than or equal to 17.5 N, greater than or equal to 20 N, greater than or equal to 22.5 N, greater than or equal to 25 N, greater than or equal to 27.5 N, greater than or equal to 30 N, greater than or equal to 32.5 N, greater than or equal to 35 N, greater than or equal to 37.5 N, greater than or equal to 40 N, greater than or equal to 42.5 N, greater than or equal to 45 N, or greater than or equal to 47.5 N. In some embodiments, a battery separator has a puncture strength of less than or equal to 50 N, less than or equal to 47.5 N, less than or equal to 45 N, less than or equal to 42.5 N, less than or equal to 40 N, less than or equal to 37.5 N, less than or equal to 35 N, less than or equal to 32.5 N, less than or equal to 30 N, less than or equal to 27.5 N, less than or equal to 25 N, less than or equal to 22.5 N, less than or equal to 20 N, less than or equal to 17.5 N, less than or equal to 15 N, less than or equal to 12.5 N, less than or equal to 10 N, less than or equal to 9 N, less than or equal to 8 N, or less than or equal to 7 N. Combinations of the above-referenced ranges are also possible (e.g., greater than or equal to 6 N and less than or equal to 50 N, greater than or equal to 8 N and less than or equal to 45 N, or greater than or equal to 10 N and less than or equal to 40 N). Other ranges are also possible.

The puncture strength of a battery separator may be determined in accordance with BCIS-03B-2018.

The battery separator described herein may have any of a variety of suitable air permeabilities. In some embodiments, a battery separator has a relatively high air permeability. In some embodiments, a battery separator has an air permeability of greater than or equal to 3 CFM, greater than or equal to 3.5 CFM, greater than or equal to 4 CFM, greater than or equal to 4.5 CFM, greater than or equal to 5 CFM, greater than or equal to 7.5 CFM, greater than or equal to 10 CFM, greater than or equal to 12.5 CFM, greater than or equal to 15 CFM, greater than or equal to 17.5 CFM, greater than or equal to 20 CFM, greater than or equal to 22.5 CFM, greater than or equal to 25 CFM, or greater than or equal to 27.5 CFM. In some embodiments, a battery separator has an air permeability of less than or equal to 30 CFM, less than or equal to 27.5 CFM, less than or equal to 25 CFM, less than or equal to 22.5 CFM, less than or equal to 20 CFM, less than or equal to 17.5 CFM, less than or equal to 15 CFM, less than or equal to 12.5 CFM, less than or equal to 10 CFM, less than or equal to 7.5 CFM, less than or equal to 5 CFM, less than or equal to 4.5 CFM, less than or equal to 4 CFM, or less than or equal to 3.5 CFM. Combinations of the above-referenced ranges are also possible (e.g., greater than or equal to 3 CFM and less than or equal to 30 CFM, greater than or equal to 4 CFM and less than or equal to 25 CFM, greater than or equal to 5 CFM and less than or equal to 20 CFM). Other ranges are also possible.

The air permeability of a battery separator may be determined in accordance with ASTM D737-04 (2016) at a pressure of 125 Pa.

The battery separators described herein may have any of a variety of suitable ionic resistances. In some embodiments, a battery separator has an ionic resistance of greater than or equal to 20 mOhm·cm², greater than or equal to 22.5 mOhm·cm², greater than or equal to 25 mOhm·cm², greater than or equal to 27.5 mOhm·cm², greater than or equal to 30 mOhm·cm², greater than or equal to 40 mOhm·cm², greater than or equal to 50 mOhm·cm², greater than or equal to 60 mOhm·cm², greater than or equal to 70 mOhm·cm², greater than or equal to 80 mOhm·cm², greater than or equal to 90 mOhm·cm², greater than or equal to 100 mOhm·cm², greater than or equal to 125 mOhm·cm², greater than or equal to 150 mOhm·cm², or greater than or equal to 175 mOhm·cm². In some embodiments, a battery separator has an ionic resistance of less than or equal to 20 mOhm·cm², less than or equal to 200 mOhm·cm², less than or equal to 175 mOhm·cm², less than or equal to 150 mOhm·cm², less than or equal to 125 mOhm·cm², less than or equal to 100 mOhm·cm², less than or equal to 90 mOhm·cm², less than or equal to 80 mOhm·cm², less than or equal to 70 mOhm·cm², less than or equal to 60 mOhm·cm², less than or equal to 50 mOhm·cm², less than or equal to 40 mOhm·cm², less than or equal to 30 mOhm·cm², less than or equal to 27.5 mOhm·cm², less than or equal to 25 mOhm·cm², or less than or equal to 22.5 mOhm·cm². Combinations of the above-referenced ranges are also possible (e.g., greater than or equal to 20 mOhm·cm² and less than or equal to 200 mOhm·cm², greater than or equal to 25 mOhm·cm² and less than or equal to 150 mOhm·cm², greater than or equal to 30 mOhm·cm² and less than or equal to 100 mOhm·cm²). Other ranges are also possible.

The air permeability of a battery separator may be determined in accordance with BCIS-03B-2018.

As described above, some embodiments relate to lead-acid batteries, such as lead-acid batteries comprising the battery separators described herein. However, the battery separators may also be used for other battery types and references to lead-acid batteries herein should be understood not to be limiting. Lead-acid batteries typically comprise a first battery plate (e.g., a negative battery plate) that comprises lead and a second battery plate (e.g., a positive battery plate) that comprises lead dioxide. During discharge, electrons pass from the first battery plate to the second battery plate while the lead paste in the first battery plate is oxidized to form lead sulfate and the lead dioxide in the second battery plate is reduced to also form lead sulfate. During charge, electrons pass from the second battery plate to the first battery plate while the lead sulfate in the first battery plate is reduced to form lead and the lead sulfate in the second battery plate is oxidized to form lead dioxide. Lead-acid batteries may further comprise an electrolyte (e.g., an electrolyte comprising sulfuric acid) that is configured to transport hydrogen and/or sulfate ions between the first and second battery plates during discharge in charge. One or more battery separators may be positioned between the first and second battery plates.

The battery separators described herein may be used in lead-acid batteries for any of a variety of suitable applications. Such applications include, but are not limited to, valve regulated lead-acid (VRLA) battery applications (e.g., absorbed glass-mat (AGM) battery applications), flooded battery applications, and/or enhanced flooded battery applications. In some embodiments, the battery separator described herein may be particularly suited for flooded battery applications and/or enhanced flooded battery applications, which are often operated at harsher operating environments compared to typical lead-acid batteries.

Some embodiments relate to a lead-acid battery that is a flooded battery, such as a flooded battery comprising one or more of the battery separators described herein. The flooded battery may be a conventional flooded battery, or may be an enhanced flooded battery. In some embodiments, a flooded battery is unsealed and exhausts gases produced therein (e.g., during discharge, during charge) to the environment surrounding the battery through one or more vents therein. These vents may, additionally or alternatively, allow acid, steam, condensation, and/or other species to flow into and/or out of the flooded battery. Enhanced flooded batteries may have several advantages in comparison to other types of lead-acid batteries. For instance, enhanced flooded batteries may exhibit more than twice the partial state of charge and deep-cycling performance of conventional lead-acid batteries, may be capable of providing power during a high number of engine starts and/or extended engine-off periods, may exhibit improved charge acceptance in comparison to conventional lead-acid batteries, may be designed to withstand hot environments (e.g., engine compartments, hot climates), and/or may be particularly suited for use in start-stop vehicle technologies with limited energy regeneration.

Battery plates described herein typically comprise a battery paste disposed on a grid. A battery paste included in a negative battery plate may comprise lead, and/or may comprise both lead and lead dioxide (e.g., prior to full charging, during fabrication, battery assembly, and/or during one or more portions of a method described herein). A battery paste included in a positive battery plate may comprise lead dioxide, and/or may comprise both lead and lead dioxide (e.g., prior to full charging, during fabrication, during battery assembly, and/or during one or more portions of a method described herein). Grids, in some embodiments, include lead and/or a lead alloy.

In some embodiments, one or more battery plates may further comprise one or more additional components. For instance, a battery plate may comprise a reinforcing material, such as an expander. When present, an expander may comprise barium sulfate, carbon black and lignin sulfonate as the primary components. The components of the expander(s) (e.g., carbon black and/or lignin sulfonate, if present, and/or any other components) can be pre-mixed or not pre-mixed. In some embodiments, a battery plate may comprise a commercially available expander, such as an expander produced by Hammond Lead Products (Hammond, Ind.) (e.g., a Texex® expander) or an expander produced by Atomized Products Group, Inc. (Garland, Tex.). Further examples of reinforcing materials include chopped organic fibers (e.g., having an average length of 0.125 inch or more), chopped glass fibers, metal sulfate(s) (e.g., nickel sulfate, copper sulfate), red lead (e.g., a Pb₃O₄-containing material), litharge, and paraffin oil.

It should be understood that while the additional components described above may be present in any combination of battery plates in a battery, some additional components may be especially advantageous for some types of battery plates. For instance, expanders, metal sulfates, and paraffins may be especially advantageous for use in positive battery plates. One or more of these components may be present in a positive battery plate, and absent in a negative battery plate. Some additional components described above may have utility in many types of battery plates. Non-limiting examples of such components include fibers (e.g., chopped organic fibers, chopped glass fibers). These components may, in some embodiments, be present in both negative and positive battery plates.

As mentioned previously, in some embodiments, a battery separator comprises two phases (e.g., a first phase and a second phase), where each phase is either a non-woven fiber web or a portion of a non-woven fiber web. In embodiments where a phase is a non-woven fiber web, each phase may be formed separately and combined by any suitable method to form the final battery separator. Such methods may include lamination, collation, and/or the use of adhesives. The two or more non-woven fiber webs may be formed using different processes, or by using the same process. For example, each of the non-woven fiber webs may be independently formed by a wet laid process, a non-wet laid process, or any other suitable process.

In some embodiments, a phase that is a non-woven fiber web is fabricated by a wet laying process. In general, a wet laying process involves mixing together fibers of one or more type; for example, a plurality of glass fibers may be mixed together on its own or with a plurality of synthetic fibers to provide a fiber slurry. The slurry may be, for example, an aqueous-based slurry. In some embodiments, fibers are optionally stored separately, or in combination, in various holding tanks prior to being mixed together.

In some embodiments, each plurality of fibers may be mixed and pulped together in separate containers. As an example, a plurality of glass fibers may be mixed and pulped together in one container and a plurality of synthetic fibers may be mixed and pulped in a second container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture (e.g., additives). Furthermore, it should be appreciated that other combinations of fibers types may be used in fiber mixtures, such as the fiber types described herein.

A wet laying process may comprise applying a single dispersion (e.g., a pulp) in a solvent (e.g., an aqueous solvent such as water) or slurry onto a wire conveyor in a papermaking machine (e.g., a fourdrinier or a rotoformer) to form a single non-woven fiber web supported by the wire conveyor. Vacuum may be continuously applied to the dispersion of fibers during the above process to remove the solvent from the fibers, thereby resulting in an article containing the single non-woven fiber web. In some embodiments, a polymer resin may be applied onto the article to impart advantageous properties (e.g., enhanced mechanical strength, etc.) to the article.

Any suitable method for creating a fiber slurry may be used. In some embodiments, further additives are added to the slurry to facilitate processing. The temperature may also be adjusted to a suitable range, for example, between 33° F. and 100° F. (e.g., between 50° F. and 85° F.). In some cases, the temperature of the slurry is maintained. In some instances, the temperature is not actively adjusted.

In some embodiments, a wet laying process uses similar equipment as in a conventional papermaking process, for example, a hydropulper, a former or a headbox, a dryer, and/or an optional converter. A non-woven fiber web can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of the fibers is in a suitable range, such as for example, between about 0.1% and 0.5% by weight.

In some cases, the pH of the slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

During or after formation of a non-woven web, the non-woven web may be further processed according to a variety of known techniques. Optionally, additional layers can be formed and/or added to a non-woven web using processes such as lamination, co-pleating, or collation. For example, in some cases, two non-woven fiber webs are formed a by separate wet laid processes, and the non-woven fiber webs are then combined with an additional non-woven fiber web by any suitable process (e.g., lamination, co-pleating, or collation).

In embodiments in which a battery separator comprises two or more phases in a common non-woven fiber web (e.g., a multi-phase non-woven fiber web), the at least two phases may be formed simultaneously and/or sequentially in a wet laying process. For instance, multiple phases may be formed sequentially in a wet laying process to fabricate a multi-phase non-woven fiber web. As one example, a first phase may be formed as described above with respect to the formation of non-woven fiber webs, and then one or more further phases may be formed on that phase by following the same procedure. When a first and second phase are formed simultaneously, a first fiber slurry may initially be applied onto a wire conveyor. Then, a second fiber slurry comprising fibers may be applied onto the first fiber slurry. Vacuum may be continuously applied to the first and second slurries during the above processes to remove solvent from the fibers, which may result in the simultaneous formation of the first phase, the second phase, and a dual-phase non-woven fiber web comprising these first and second phases. The application of vacuum may also cause some fibers from the second fiber slurry to be pulled down into the first fiber slurry and/or to intermingle with at least a portion of the fibers in the first fiber slurry (e.g., at the interface between the two fiber slurries), which may result in the formation of a transition phase positioned between the first and second phases. After the application of vacuum, the composite article may then be dried. Further phases may be formed on the first phase and the second phase by following this same process. The resultant multi-phase non-woven fiber web may be combined with one or more additional layers as described above with respect to single-phase non-woven fiber webs.

After formation of a battery separator, the battery separator may or may not be crimped (e.g., sealed) along the edges to form a pocket. In some embodiments in which the battery separator is crimped to form a pocket, a battery plate (e.g., positive or negative) may be placed inside the pocket to prevent battery shorts during cycling. As noted above, the presence of synthetic fibers in the separator may increase the crimpability of the separator, such that the separator may be easily crimped.

After fabrication, the battery separators and battery plates may be assembled into a stack. After assembly, the stack may optionally be compressed, which may reduce the thickness of one or more components therein. Then, the compressed or uncompressed stack may be placed (e.g., directly inserted) into a battery casing. Finally, an electrolyte, such as 1.285 spg sulfuric acid, may be added to the battery.

After assembly, the battery may undergo a formation step, during which the battery becomes fully charged and ready for operation. Formation may involve passing an electric current through an assembly of alternating negative and positive battery plates separated by separators. During formation, the battery paste in the negative and positive battery plates may be converted into negative and positive active materials, respectively. For example, lead oxide in a battery paste disposed on the negative battery plate may be transformed into lead, and/or lead oxide in a battery paste disposed on the positive battery plate may be transformed into lead dioxide.

The battery separators described herein may have a variety of suitable designs. In some embodiments, the battery separator is a leaf separator. Other suitable types of battery separators include, but are not limited to, folded separators, pocket separators, z-fold separators, sleeve separators, corrugated separators, C-wrap separators, and U-wrap separators. In one non-limiting embodiment of a folded separator, the separator may be folded around a battery plate when positioned in a lead-acid battery. In one non-limiting embodiment of a pocket separator, the separator is sealed on three sides and is open on the final side. A battery plate may be positioned inside the pocket formed by this separator when positioned in a lead-acid battery.

### EXAMPLE 1

This Example describes a battery separator comprising a first phase and a second phase and compares the properties of the first phase to the second phase.

Five dual-phase battery separators (Sample 1, Sample 2, Sample 3, Sample 4, and Sample 5) were formed by a wet laying process. For each sample, a dual-phase non-woven fiber web was first formed using the wet laying process. Each dual-phase non-woven fiber web included two phases positioned in a common non-woven fiber web—a first phase (a fine phase) and a second phase (a coarse phase). The first phase and the second phase had the same composition in each sample, but were present at different relative basis weights. After fabrication, each dual-phase non-woven fiber web was saturated with a liquid latex that contained 2 wt % acrylic resin. Vacuum was then applied to the saturated fiber sheets to remove any excess liquid resin, after which each sample was dried at 100° C. to remove any remaining moisture and then further heated at 150° C. to cure the resin to form a dual-phase separator.

Table 1, below, shows selected physical properties of each sample and Table 2, also below, shows the furnishes of the fine phase and the coarse phase employed for all samples.

TABLE 1

| Properties | Sample 1 | Sample 2 | Sample 3 | Sample 4 | Sample 5 |
|---|---|---|---|---|---|
| Basis weight of | 95 | 85 | 70 | 60 | 45 |
| fine phase (gsm) | | | | | |
| Basis weight of | 45 | 55 | 70 | 80 | 95 |
| coarse phase | | | | | |
| (gsm) | | | | | |
| Thickness ratio | 0.57 | 0.68 | 0.97 | 1.62 | 2.01 |
| of coarse phase | | | | | |
| to finer phase | | | | | |
| Ionic resistance | 40.52 | 36.51 | 33.04 | 26.54 | 21.56 |
| of the separator | | | | | |
| (mOhm · cm²) | | | | | |
| Air permeability | 11.2 | 12.7 | 14.6 | 16.8 | 19.4 |
| of the separator | | | | | |
| (CFM) | | | | | |
| Mean flow pore | 6.31 | 6.51 | 6.76 | 7.15 | 7.70 |
| size of the | | | | | |
| separator | | | | | |
| (microns) | | | | | |
| Puncture | 15.1 | 15.8 | 15.1 | 15.1 | 14.6 |
| strength of the | | | | | |
| separator (N) | | | | | |

TABLE 2

| Fiber Type | Fine phase | Coarse phase |
|---|---|---|
| Fine glass fibers | 75 | 13 |
| (1.4 micron average fiber diameter) | | |
| (wt %) | | |
| Coarse glass fibers | 0 | 67 |
| (8.5 micron average fiber diameter) | | |
| (wt %) | | |
| Synthetic polyester fibers | 25 | 20 |
| (11.8 micron average fiber diameter) | | |
| (wt %) | | |

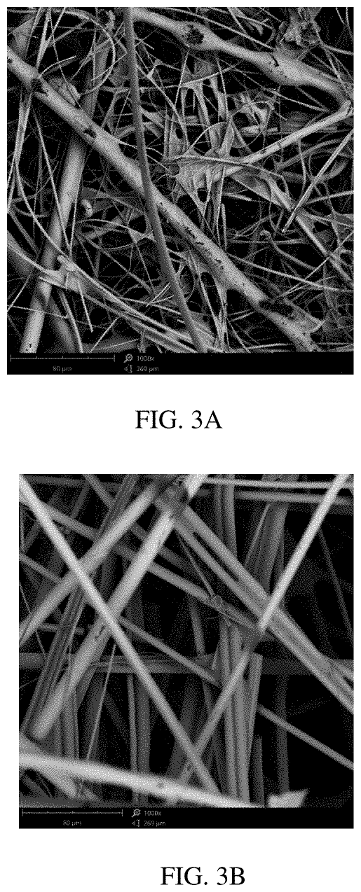

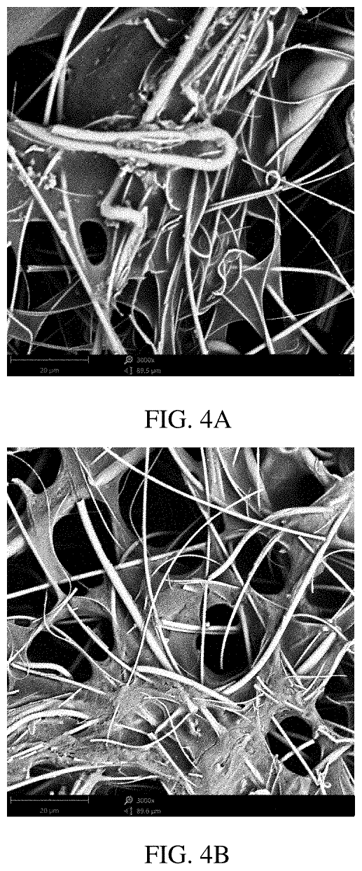

A SEM image of the fine phase is shown in FIG. 3A and a SEM image of the course phase is shown in FIG. 3B. Since the fine phase contained fibers having a smaller overall average fiber diameter than the fibers in the coarse phase, the fine phase exhibited a finer pore structure than the coarse phase.

Physical properties of battery separators are shown in Table 1. As shown in Table 1, as the thickness ratio of the coarse phase to the fine phase increased, the battery separators exhibited an increase in air permeability and a decrease in ionic resistance. Additionally, the battery separators exhibited puncture strengths that were relatively independent of the relative thicknesses and basis weights of the individual phases.

In accordance with some embodiments, a battery separator may be crimped after fabrication. To demonstrate this, a battery separator was crimped after fabrication along the two edges (as shown in FIG. 6).

### EXAMPLE 2

This Example describes the storage of a battery separator in an acid and compares the morphology of the separator before and after its storage.

A dual-phase battery separator comprising a fine phase and a coarse phase was fabricated by the wet laying process described in Example 1. The fiber furnishes for the fine phase and the coarse phase are shown below in Table 3. After the dual-phase non-woven fiber web was formed, it was saturated with a liquid latex containing 3 wt % acrylic resin. Vacuum was then applied to the saturated dual-phase non-woven fiber web to remove any excess liquid resin, after which the sample was dried at 100° C. to remove any remaining moisture. The sample was then heated at 150° C. to cure the resin to form a dual-phase separator.

TABLE 3

| Fiber Type | Fine phase | Coarse phase |
|---|---|---|
| Fine glass fibers (wt %) | 75 | 0 |
| (1.4 micron average fiber diameter) | | |
| Coarse glass fibers (wt %) | 0 | 80 |
| (8.5 micron average fiber diameter) | | |
| Synthetic polyester fibers (wt %) | 15 | 10 |
| (11.8 micron average fiber diameter) | | |
| Synthetic bicomponent polyester- | 10 | 10 |
| polyethylene fibers (wt %) | | |
| (12.1 micron average fiber | | |
| diameter:) | | |
| Basis weight (gsm) | 55 | 65 |

The stability of the battery separator in acid was studied by storing a piece of 10×10 cm separator sample in 200 mL of a H₂SO₄ solution (spg=1.285) at 70° C. After 3 weeks, the sample was thoroughly washed with water then dried.

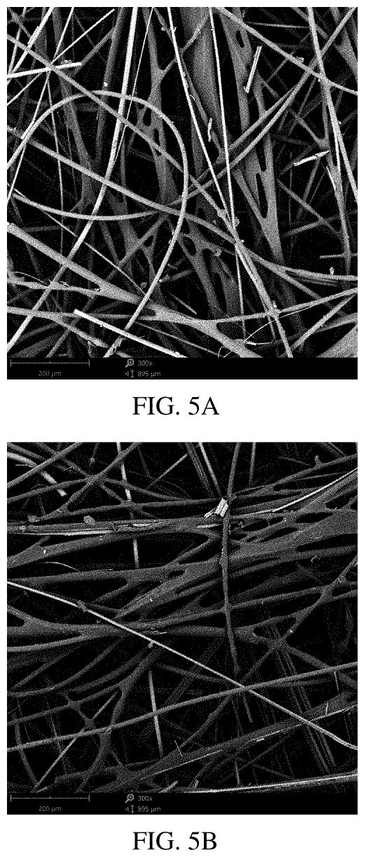

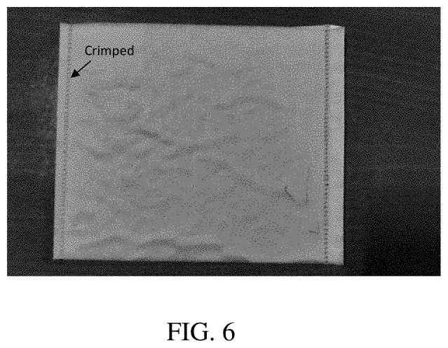

FIGS. 4A-4B are SEM images of the fine phase before (FIG. 4A) and after acid storage (FIG. 4B). FIGS. 5A-5B are SEM images of the coarse phase before (FIG. 5A) and after acid storage (FIG. 5B). As shown, the fibers in each phase still remained bonded together after the acid storage, suggesting that the battery separator had good stability in the presence of sulfuric acid and that the acrylic resin was acid-stable.

### EXAMPLE 3

This Example describes and compares the cold-cranking performance of a 2V flooded lead acid battery comprising multiple leaf separators having the features described in Example 2 with an otherwise equivalent 2V flooded lead acid battery instead comprising multiple ribbed polyethylene separators. In both cases, each adjacent pair of battery plates was separated by a battery separator.

Table 4 shows selected physical properties for the battery comprising the dual-phase separator described in Example 2 and the otherwise equivalent cell that comprised a polyethylene separator with ribs. The discharge capacity of each battery was determined in accordance with BS EN50342-1 (2018). Specifically, the discharge capacity was measured by discharging each fully-charged battery at a constant current of 1.5 A until the voltage of the batteries reached 1.75 V. As shown in Table 4, both batteries delivered similar capacities.

TABLE 4

| | Dual-phase | Polyethylene separator |
|---|---|---|
| Parameter | separator | with ribs |
| Design of plate assembly | 4 negative plates/3 | 4 negative plates/3 |
| | positive plates | positive plates |
| Positive plate dimensions | 5.88 × 5 | 5.88 × 5 |
| (inches) | | |
| Negative plate dimensions | 5.81 × 5 | 5.81 × 5 |
| (inches) | | |
| Separator dimensions | 6.35 × 5.5 | 6.35 × 5.5 |
| (inches) | | |
| Portion of battery separator | Coarse phase | Ribs |
| directly adjacent to battery | | |
| plates | | |
| Thickness of the separator | 1.125 | 0.95 |
| (mm) | | |
| Ionic resistance of the | 40 | 62.8 |
| separator (mOhm · cm²) | | |
| Mass of sulfuric electrolyte | 501 | 501 |
| (g) filled into cells | | |
| Specific gravity of sulfuric | 1.262 | 1.262 |
| acid electrolyte | | |
| Discharge capacity (Ah) | 39.2 | 40.5 |
| under constant current of | | |
| 1.5 A | | |

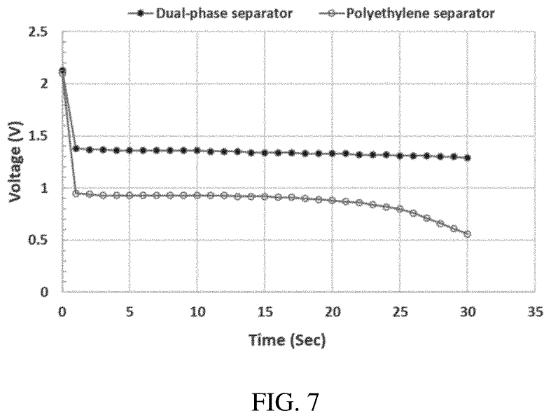

FIG. 7 shows a plot of the discharge voltage as a function of time for the batteries during a cold-cranking test, which was conducted in accordance with BS EN50342-6 (2018). During testing, each fully-charged battery was stored at −18° C. for 24 hours and then discharged at a constant current of 280 A for 30 seconds. The battery comprising the dual-phase separator of Example 2 exhibited a significantly higher voltage than the polyethylene separator throughout the test, demonstrating its higher rate capability. This significantly higher voltage exhibited by the battery comprising the dual-phase separator could be attributed to the lower ionic resistance of the dual-phase separator compared to the polyethylene separator.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A lead-acid battery, comprising:
battery plates; and
a battery separator, comprising:
a first phase and a second phase, wherein:
the first phase comprises fibers;
the second phase comprises fibers;
the first phase has a mean flow pore size of greater than or equal to 2 microns and less than or equal to 15 microns;
the second phase has a mean flow pore size of greater than or equal to 20 microns and less than or equal to 150 microns; and
the battery separator has an air permeability of greater than or equal to 3 CFM and less than or equal to 30 CFM.

2. A battery separator, comprising:
a first phase and a second phase, wherein:
glass fibers make up greater than 40 wt % of the first phase;
glass fibers make up greater than 40 wt % of the second phase;
the first phase comprises fibers having an average fiber diameter of greater than or equal to 0.5 microns and less than or equal to 12 microns;
the second phase comprises fibers having an average fiber diameter of greater than or equal to 5 microns and less than or equal to 20 microns;
a ratio of the thickness of the second phase to the thickness of the first phase is greater than or equal to 1.15;
an acid-stable binder resin makes up greater than or equal to 2 wt % and less than or equal to 30 wt % of the battery separator; and
the battery separator has an air permeability of greater than or equal to 3 CFM and less than or equal to 30 CFM.

3. A lead-acid battery as in claim 1, wherein the first phase comprises fibers having an average fiber diameter of greater than or equal to microns and less than or equal to 12 microns.

4. (canceled)

5. A lead-acid battery as in claim 1, wherein the second phase comprises fibers having an average fiber diameter of greater than or equal to 5 microns and less than or equal to 20 microns.

6. (canceled)

7. A lead-acid battery as in claim 1, wherein the second phase comprises fibers having a larger average fiber diameter than the fibers in the first phase.

8-9. (canceled)

10. A lead-acid battery as in claim 1, wherein a ratio of the thickness of the second phase to the thickness of the first phase is greater than or equal to 1.15.

11-12. (canceled)

13. A lead-acid battery as in claim 1, wherein glass fibers make up greater than 40 wt % of the first phase.

14. (canceled)

15. A lead-acid battery as in claim 1, wherein glass fibers make up greater than 40 wt % of the second phase.

16. (canceled)

17. A lead-acid battery as in claim 1, wherein the first phase comprises glass fibers having an average fiber diameter of greater than or equal to 0.5 microns and less than or equal to 10 microns.

18. A lead-acid battery as in claim 1, wherein the second phase comprises glass fibers having an average fiber diameter of greater than or equal to 4 microns and less than or equal to 20 microns.

19. (canceled)

20. A lead-acid battery as in claim 1, wherein synthetic fibers make up greater than 5 wt % and less than or equal to 45 wt % of the first phase and/or the second phase.

21. (canceled)

22. A lead-acid battery as in claim 1, wherein the first phase and/or the second phase comprise synthetic fibers having an average fiber diameter of greater than or equal to 1 micron and less than or equal to 20 microns.

23. (canceled)

24. A lead-acid battery as in claim 20, wherein the synthetic fibers comprise polyester.

25. (canceled)

26. A lead-acid battery as in claim 1, wherein the battery separator further comprises a binder resin, and wherein the binder resin is an acid-stable binder resin.

27. (canceled)

28. A lead-acid battery as in claim 26, wherein the binder resin comprises acrylic latex resin.

29-32. (canceled)

33. A lead-acid battery as in claim 26, wherein the binder resin makes up greater than or equal to 2 wt % and less than or equal to 30 wt % of the battery separator.

34. (canceled)

35. A lead-acid battery as in claim 1, wherein the battery separator has a puncture strength of greater than or equal to 6 N and less than or equal to 50 N.

36. A lead-acid battery as in claim 1, wherein the battery separator has an ionic resistance of greater than or equal to 20 mOhm·cm² and less than or equal to 200 mOhm·cm².

37-40. (canceled)

41. A lead-acid battery as in claim 1, wherein the battery separator has a mean flow pore size of greater than or equal to 3 microns and less than or equal to 30 microns.

42-44. (canceled)

45. A lead-acid battery as in claim 1, wherein the first phase is formed on the top of the second phase during a wet-laid process.

46-54. (canceled)
